(19) United States
(12) Patent Application Publication
(10) Pub. No.: US 2015/0111118 A1
(43) Pub. Date: Apr. 23, 2015

(54) PHOTOELECTROCHEMICAL CELL AND HYDROGEN GENERATION METHOD USING THE SAME

(71) Applicant: PANASONIC CORPORATION, Osaka (JP)

(72) Inventors: TAKAIKI NOMURA, Osaka (JP); SATORU TAMURA, Osaka (JP); RYOSUKE KIKUCHI, Osaka (JP); YOSHIHIRO KOZAWA, Osaka (JP); TAKAHIRO KURABUCHI, Osaka (JP); KAZUHITO HATO, Osaka (JP)

(21) Appl. No.: 14/492,084

(22) Filed: Sep. 22, 2014

(30) Foreign Application Priority Data
Oct. 17, 2013 (JP) 2013-216377

(51) Int. Cl. C25B 1/00; C25B 1/04; C25B 11/04; H01M 8/06

(52) U.S. Cl. CPC C25B 1/003; H01M 8/0656; C25B 1/04; C25B 11/0478; C25B 11/0452
USPC 429/422; 204/242; 205/340

(57) ABSTRACT

The present invention provides a photoelectrochemical cell. The photoelectrochemical cell comprises a semiconductor photoelectrode which functions as a cathode electrode; a counter electrode which functions as an anode electrode; an electrolyte aqueous solution which is in contact with surfaces of the semiconductor photoelectrode and the counter electrode; and a container containing the semiconductor photoelectrode, the counter electrode, and the electrolyte aqueous solution. The semiconductor photoelectrode includes: a first conductive layer; an n-type semiconductor layer disposed on the first conductive layer; and a second conductive layer which completely covers a surface of the n-type semiconductor layer. The counter electrode is electrically connected to the first conductive layer. The second conductive layer is light-transmissive. The second conductive layer functions as a light incident surface.

### BACKGROUND

1. Technical Field

The present invention relates to a photoelectrochemical cell and a hydrogen generation method using the same.

2. Description of the Related Art

A semiconductor material which functions as a photocatalyst is irradiated with light to split water into oxygen and hydrogen.

U.S. Pat. No. 8,236,146 discloses a photoelectrochemical cell and an energy system using the same. As shown in FIG. 17, the photoelectrochemical cell 900 disclosed in U.S. Pat. No. 8,236,146 includes: a semiconductor electrode 920 including a conductor 921 and an n-type semiconductor layer 922; a counter electrode 930 connected electrically to the conductor 921; an electrolyte 940 in contact with the surfaces of the n-type semiconductor layer 922 and the counter electrode 930; and a container 910 accommodating the semiconductor electrode 920, the counter electrode 930 and the electrolyte 940. The photoelectrochemical cell 900 generates hydrogen by irradiation of the n-type semiconductor layer 922 with light. In the semiconductor electrode 920, relative to the vacuum level, (I) the band edge levels of the conduction band and the valence band in the surface near-field region of the n-type semiconductor layer 922, respectively, are equal to or higher than the band edge levels of the conduction band and the valence band in the junction plane near-field region of the n-type semiconductor layer 922 with the conductor 921, (II) the Fermi level of the junction plane near-field region of the n-type semiconductor layer 922 is higher than the Fermi level of the surface near-field region of the n-type semiconductor layer 922, and (III) the Fermi level of the conductor 921 is higher than the Fermi level of the junction plane near-field region of the n-type semiconductor layer 922.

### SUMMARY

The present invention provides a photoelectrochemical cell, comprising:

a semiconductor photoelectrode which functions as a cathode electrode;

a counter electrode which functions as an anode electrode;

an electrolyte aqueous solution which is in contact with surfaces of the semiconductor photoelectrode and the counter electrode; and

a container containing the semiconductor photoelectrode, the counter electrode, and the electrolyte aqueous solution, wherein

the semiconductor photoelectrode includes:
a first conductive layer;
an n-type semiconductor layer disposed on the first conductive layer; and
a second conductive layer which completely covers a surface of the n-type semiconductor layer;

the n-type semiconductor layer has a first n-type surface region and a second n-type surface region;

the first n-type surface region is in contact with the first conductive layer;

the second n-type surface region is in contact with the second conductive layer;

a band edge level E_{C1} of a conduction band in the first n-type surface region is not lower than a band edge level E_{CN} of a conduction band in the second n-type surface region;

a band edge level E_{V1} of a valence band in the first n-type surface region is not lower than a band edge level E_{VN} of a valence band in the second n-type surface region;

a Fermi level E_{FN} of the second n-type surface region is not lower than a Fermi level E_{F1} of the first n-type surface region;

the Fermi level E_{F1} of the first n-type surface region is higher than a Fermi level E_{FC} of the first conductive layer;

a Fermi level E_{FT} of the second conductive layer is higher than the Fermi level E_{FN} of the second n-type surface region;

the counter electrode is electrically connected to the first conductive layer;

the second conductive layer is light-transmissive; and

the second conductive layer functions as a light incident surface.

The present invention further provides a photoelectrochemical cell, comprising:

a semiconductor photoelectrode which functions as a cathode electrode;

a counter electrode which functions as an anode electrode;

an electrolyte aqueous solution which is in contact with surfaces of the semiconductor photoelectrode and the counter electrode; and

a container containing the semiconductor photoelectrode, the counter electrode, and the electrolyte aqueous solution, wherein

the semiconductor photoelectrode includes:
a first conductive layer;
an n-type semiconductor layer disposed on the first conductive layer; and
a second conductive layer which completely covers a surface of the n-type semiconductor layer;

the n-type semiconductor layer has a first n-type surface region and a second n-type surface region;

the first n-type surface region is in contact with the first conductive layer;

the second n-type surface region is in contact with the second conductive layer;

a band edge level E_{C1} of a conduction band in the first n-type surface region is not lower than a band edge level E_{CN} of a conduction band in the second n-type surface region;

a band edge level E_{V1} of a valence band in the first n-type surface region is not lower than a band edge level E_{VN} of a valence band in the second n-type surface region;

a Fermi level E_{FN} of the second n-type surface region is not lower than a Fermi level E_{F1} of the first n-type surface region;

the Fermi level E_{F1} of the first n-type surface region is higher than a Fermi level E_{FC} of the first conductive layer;

a Fermi level E_{FT} of the second conductive layer is higher than the Fermi level E_{FN} of the second n-type surface region;

the counter electrode is electrically connected to the first conductive layer;

the second conductive layer is light-transmissive; and the second conductive layer functions as a light incident surface.

The present invention provides a photoelectrochemical cell where high quantum efficiency is maintained for a long time. The present invention also provides a method for generating hydrogen using the photoelectrochemical cell.

### BRIEF DESCRIPTION OF THE DRAWINGS

FIG. 1 shows a schematic view of a photoelectrochemical cell according to the first embodiment;

FIG. 2A shows a schematic view of the band structure before the first conductive layer 121, the n-type semiconductor layer 122, and the second conductive layer 123 form junctions in the photoelectrochemical cell 100 according to the first embodiment;

FIG. 2B shows a band structure before the joining in a case where the n-type semiconductor layer 122 is formed of a plurality of the n-type semiconductor films in which the composition is varied stepwise in the first embodiment;

FIG. 3A shows a schematic view of the band structure after the first conductive layer 121, the n-type semiconductor layer 122 and the second conductive layer 123 have formed junctions in the photoelectrochemical cell 100 according to the first embodiment;

FIG. 3B shows a band structure after the joining in a case where the n-type semiconductor layer 122 is formed of the plurality of the n-type semiconductor films in which the composition is varied stepwise in the first embodiment;

FIG. 3C shows a schematic view of the band structure after the first conductive layer 121 and the n-type semiconductor layer 122 have been joined to each other in a case where the second conductive layer 123 is not provided;

FIG. 4 shows a schematic view of the photoelectrochemical cell 100 according to the second embodiment;

FIG. 5 shows a schematic view of the band structure in the second embodiment before the joining;

FIG. 6 shows a schematic view of the band structure in the second embodiment after the joining;

FIG. 7 shows a schematic view of the photoelectrochemical cell 100 according to the third embodiment;

FIG. 8A shows a schematic view of the band structure before the first conductive layer 121, the n-type semiconductor layer 122, and the second conductive layer 123 form junctions in the photoelectrochemical cell 100 according to the third embodiment;

FIG. 8B shows a band structure before the joining in a case where the n-type semiconductor layer 122 is formed of a plurality of the n-type semiconductor films in which the composition is varied stepwise in the third embodiment;

FIG. 9A shows a schematic view of the band structure after the first conductive layer 121, the n-type semiconductor layer 122 and the second conductive layer 123 have formed junctions in the photoelectrochemical cell 100 according to the third embodiment;

FIG. 9B shows a band structure after the joining in a case where the n-type semiconductor layer 122 is formed of the plurality of the n-type semiconductor films in which the composition is varied stepwise in the third embodiment;

FIG. 10 shows a schematic view of the photoelectrochemical cell 100 according to the fourth embodiment;

FIG. 11 shows a schematic view of the band structure in the fourth embodiment before the joining;

FIG. 12 shows a schematic view of the band structure in the fourth embodiment after the joining;

FIG. 13 shows a schematic view of a variation of the photoelectrochemical cell according to the first embodiment;

FIG. 14A shows a schematic view of the photoelectrochemical cell 100 according to the fifth embodiment;

FIG. 14B shows a schematic view of a variation of the photoelectrochemical cell 100 according to the fifth embodiment;

FIG. 15 shows a schematic view of the photoelectrochemical cell 100 according to the sixth embodiment;

FIG. 16 shows a schematic view of the energy system according to the seventh embodiment; and

FIG. 17 shows a schematic view of the photoelectrochemical cell disclosed in U.S. Pat. No. 8,236,146.

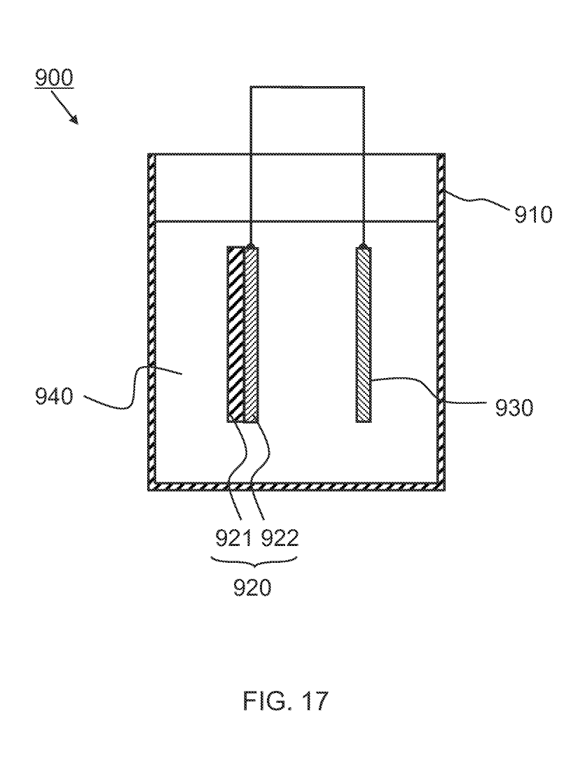

### DETAILED DESCRIPTION OF THE EMBODIMENTS

Hereinafter, the present invention will be described in detail with reference to the drawings.

### First Embodiment

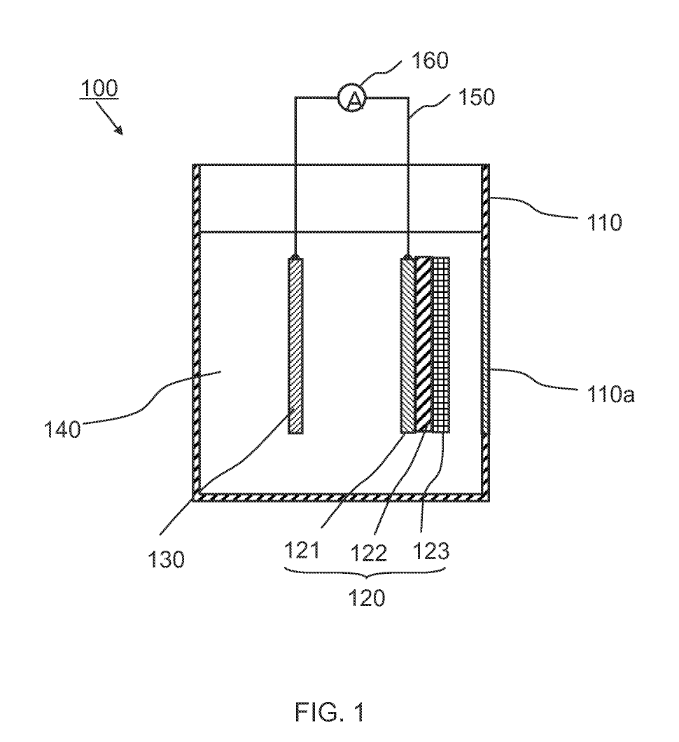

FIG. 1 shows a schematic view of a photoelectrochemical cell according to the first embodiment.

As shown in FIG. 1, the photoelectrochemical cell 100 according to the first embodiment comprises a semiconductor photoelectrode 120, a counter electrode 130, an electrolyte aqueous solution 140, a semiconductor photoelectrode 120, and a container 110. The container 110 has the electrolyte aqueous solution 140 in the inside thereof.

The semiconductor photoelectrode 120 is disposed in the container 110 such that the surface of the semiconductor photoelectrode 120 is in contact with the electrolyte aqueous solution 140. The counter electrode 130 is also disposed in the container 110 such that the surface of the counter electrode 130 is in contact with the electrolyte aqueous solution 140. The semiconductor photoelectrode 120 comprises a first conductive layer 121, an n-type semiconductor layer 122 disposed on the front surface of the first conductive layer 121, and a second conductive layer 123 which completely covers the front surface of the n-type semiconductor layer 122. The counter electrode 130 is electrically connected to the first conductive layer 121.

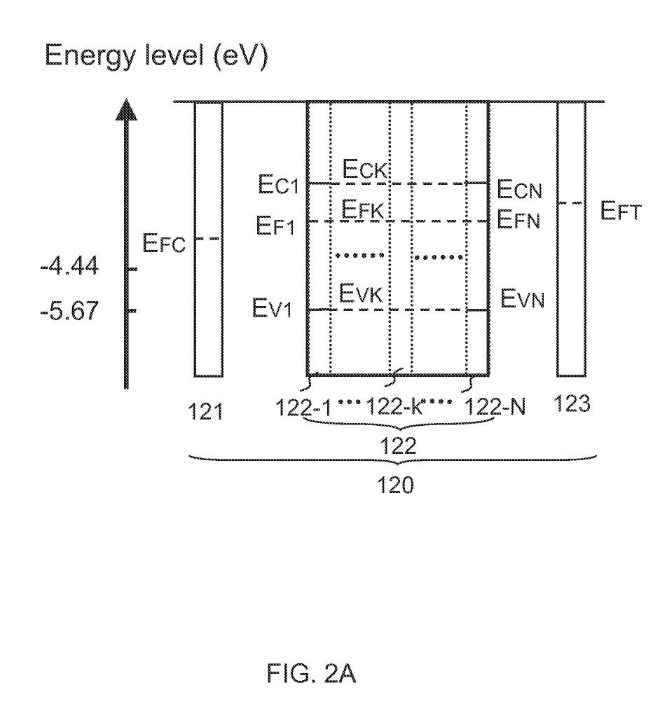

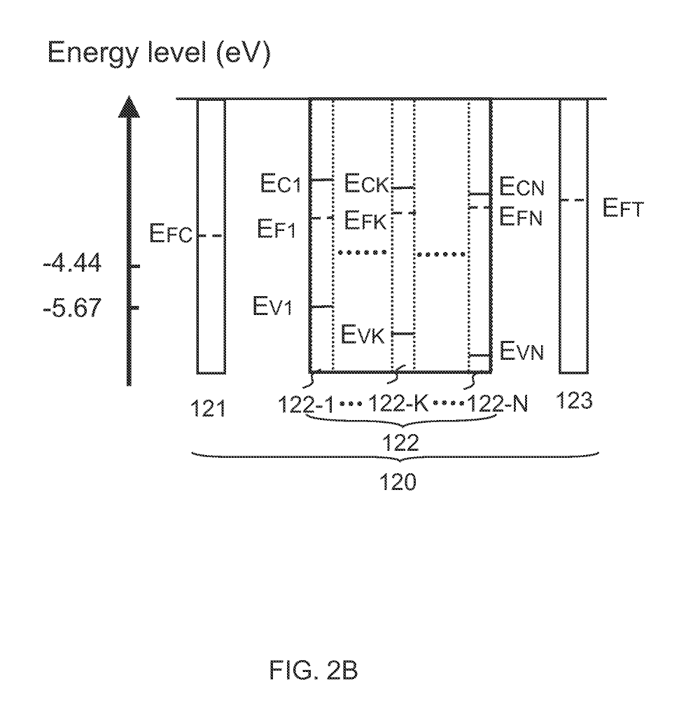

As shown in FIG. 2A, which will be described later, the n-type semiconductor layer 122 has a first n-type surface region 122-1 and a second n-type surface region 122-N in the front and back surfaces thereof, respectively. The first n-type surface region 122-1 is in contact with the first conductive layer 121. The second n-type surface region 122-N is in contact with the second conductive layer 123.

The second conductive layer 123 is light-transmissive. The second conductive layer 123 functions as a light incident surface. In other words, the second conductive layer 123 is irradiated with light. The light incident on the second conductive layer 123 travels through the second conductive layer 123 to reach the n-type semiconductor layer 122. It is desirable that at least a part of the container 110 is formed of a transparent material. In other words, it is desirable that the container 110 has a light incident part 110a formed of such a transparent material. It is desirable that light such as sunlight travels through the light incident part 110a to reach the second conductive layer 123.

The sentence “the second conductive layer 123 completely covers the front surface of the n-type semiconductor layer 122” means the surface area of the front part of the second conductive layer 123 which is in contact with the second n-type surface region 122-N is substantially equal to the surface area of the second n-type surface region 122-N . The lateral side of the n-type semiconductor layer 122 does not need to be covered with the second conductive layer 123.

The n-type semiconductor layer 122 is composed of two or more kinds of elements. Specifically, the n-type semiconductor layer 122 is formed of at least one kind of compound selected from the group consisting of an oxide, a sulfide, a selenide, a telluride, a nitride, an oxynitride, and a phosphide.

More desirably, the n-type semiconductor layer 122 is formed of at least one selected from the group consisting of an oxide semiconductor, a nitride semiconductor, and an oxynitride semiconductor. Still more desirably, the n-type semiconductor layer 122 is formed from at least one selected from the group consisting of a nitride semiconductor and an oxynitride semiconductor. When a nitride semiconductor or an oxynitride semiconductor is used, the bandgap of the n-type semiconductor layer 122 is small. Therefore, the wavelength of light absorbed by the n-type semiconductor layer 122 formed of a nitride semiconductor or an oxynitride semiconductor is longer than the wavelength of light absorbed by the n-type semiconductor layer 122 formed of an oxide semiconductor. For this reason, visible light is absorbed easily by the n-type semiconductor layer 122 formed of a nitride semiconductor or an oxynitride semiconductor. As a result, the sunlight absorption efficiency is improved and the efficiency of the photoelectrochemical cell 100 is improved.

Desirably, the n-type semiconductor layer 122 is formed of a compound including, as a constituent element, at least one kind of element selected from the group consisting of titanium, zirconium, vanadium, niobium, tantalum, chrome, molybdenum, tungsten, manganese, iron, cobalt, zinc, and cadmium. More desirably, the n-type semiconductor layer 122 is formed from a compound including, as a constituent element, at least one kind of element selected from the group consisting of titanium, zirconium, niobium, tantalum, and zinc. When the n-type semiconductor layer 122 includes at least one kind of element selected from this group, the Fermi level E_{F1} of the first n-type surface region 122-1 is set to be not lower than −4.44 eV on the basis of a vacuum level under a condition where the n-type semiconductor layer 122 is in contact with the electrolyte aqueous solution 140 having a temperature of 5 degrees Celsius at a pH of 0 under a temperature of 25 degrees Celsius. For example, the Fermi level E_{F1} of the first n-type surface region 122-1 may be set to be −4.43 eV. Alkali metal ions and/or alkaline earth metal may be added to the compound constituting the n-type semiconductor layer 122.

The first conductive layer 121 forms a Schottky junction together with the n-type semiconductor layer 122. For this reason, the materials of the first conductive layer 121 have a Fermi level lower than −4.44 eV. An example of the materials of the first conductive layer 121 is a noble metal such as Cu, Ag, Pt or Au. Pt is desirable. The Fermi level of Pt is −5.8 eV.

The second conductive layer 123 forms an ohmic contact together with the n-type semiconductor layer 122. For this reason, the materials of the second conductive layer 123 have a Fermi level higher than −4.44 eV. An example of the materials of the second conductive layer 123 is a transparent conductive oxide such as indium tin oxide (hereinafter, referred to as “ITO”), fluorine-doped tin oxide (hereinafter, referred to as “FTO”) or antimony-doped tin oxide (hereinafter, referred to as “ATO”). An n-type oxide is desirable. The Fermi level of ITO is −4.24 eV. In the comparative example 4, which will be described later, the material of the second conductive layer 123 is NiO. NiO has a Fermi level of −5.04 eV, which is lower than −4.4 eV.

The second conductive layer 123 is formed on the outermost surface of the semiconductor photoelectrode 120. In other words, the front surface of the second conductive layer 123 is exposed so as to be in contact with the electrolyte aqueous solution 140. The back surface of the second conductive layer 123 is in contact with the n-type semiconductor layer 122. The second conductive layer 123 is a dense film formed on the n-type semiconductor layer 122. When the photoelectrochemical cell 100 is used in a condition where the semiconductor photoelectrode 120 is in contact with the electrolyte aqueous solution 140, the second conductive layer 123 protects the n-type semiconductor layer 122 from the electrolyte aqueous solution 140. In other words, the second conductive layer 123 prevents the n-type semiconductor layer 122 from being in direct contact with water. For this reason, self-oxidation of the n-type semiconductor layer 122 hardly occurs. “Self-oxidation” is an oxidation reaction caused by the reaction between holes generated by the light excitation on the n-type semiconductor layer 122 and hydroxyl groups (OH) derived from water. For this reason, the high quantum efficiency is maintained for a longer time in the semiconductor photoelectrode 120 according to the first embodiment, as compared to a conventional semiconductor photoelectrode where the front surface of the n-type semiconductor layer 122 is in direct contact with water. In other words, the semiconductor photoelectrode 120 according to the first embodiment maintains the high quantum efficiency for a longer time, as compared to a conventional semiconductor photoelectrode where the front surface of the n-type semiconductor layer 122 is exposed.

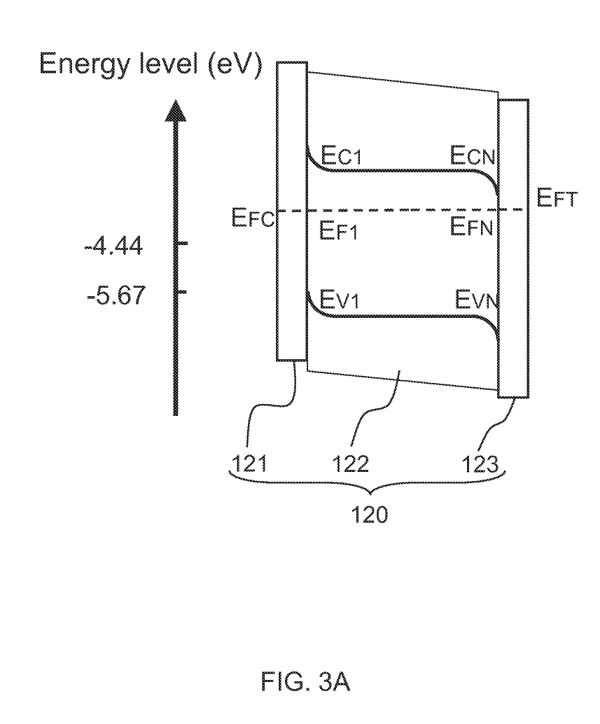

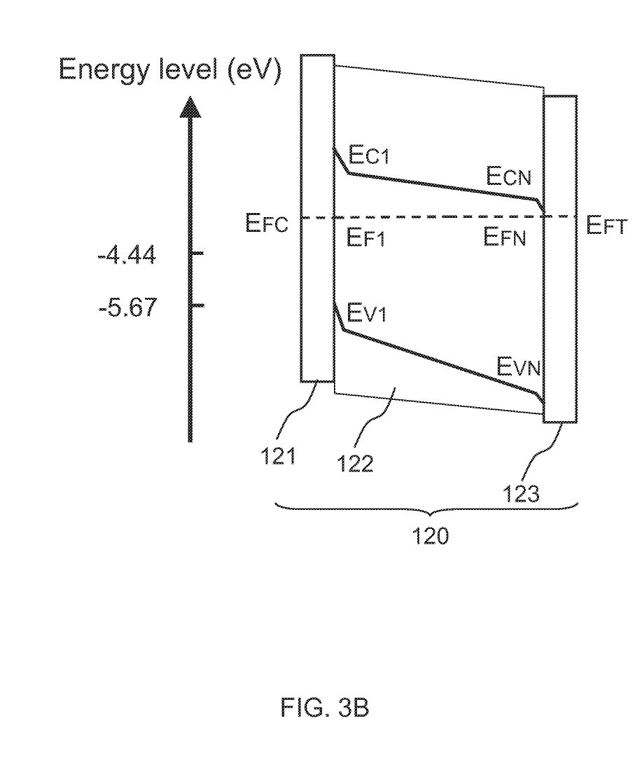

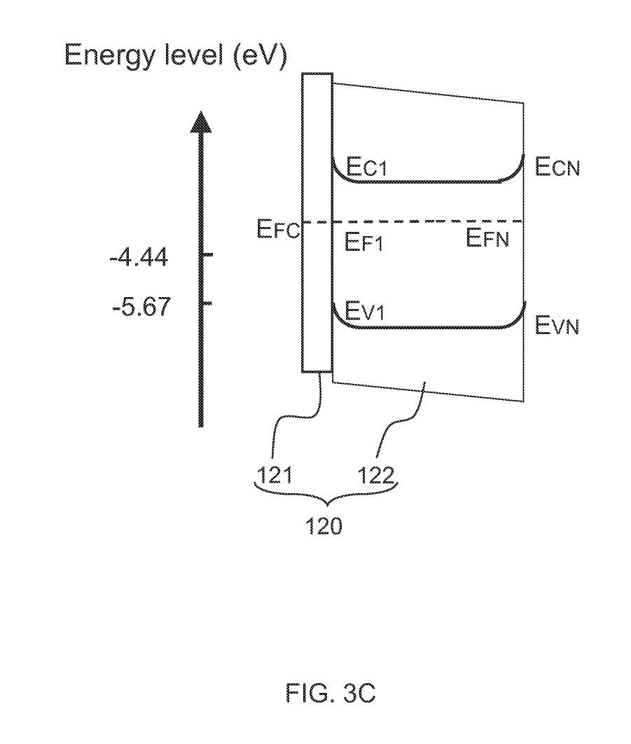

As described later in more detail, in case where the second conductive layer 123 is not provided, the n-type semiconductor layer 122 is in contact with the electrolyte aqueous solution 140. However, the n-type semiconductor layer 122 and the electrolyte aqueous solution 140 form a Schottky junction. For this reason, hydrogen is not generated on the front surface of the n-type semiconductor layer 122, even when the n-type semiconductor layer 122 is irradiated with light. See FIG. 3C, which will be described later.

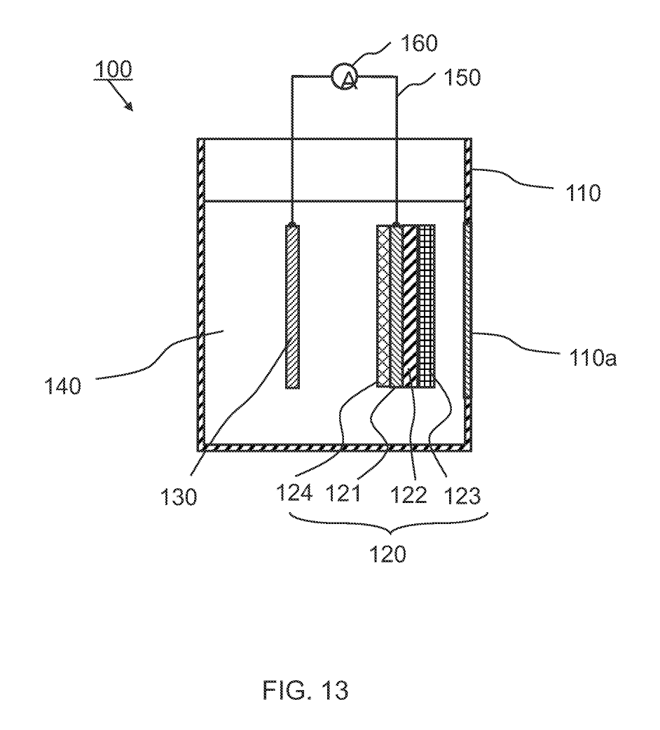

It is desirable that a part of the surface of the first conductive layer 121 which has not been covered with the n-type semiconductor layer 122 is covered with an insulator formed of, for example, a resin. Such a constitution prevents the first conductive layer 121 from being dissolved in the electrolyte aqueous solution 140. Specifically, as shown in FIG. 13, the back surface of the first conductive layer 121 is provided with an insulating layer 124. Desirably, the insulating layer 124 completely covers the back surface of the first conductive layer 121. The insulating layer 124 prevents the first conductive layer 121 from being dissolved in the electrolyte aqueous solution 140. An example of the materials of the insulating layer 124 is a resin or glass.

The first conductive layer 121 is electrically connected to the counter electrode 130 through a conducting wire 150. The term “counter electrode” means an electrode capable of receiving or supplying electrons from or to the semiconductor photoelectrode 120 without the electrolyte aqueous solution 140. The positional relation between the counter electrode 130 and the semiconductor photoelectrode 120 is not limited, as far as the counter electrode 130 is electrically connected to the first conductive layer 121. In the first embodiment, the counter electrode 130 supplies electrons to the semiconductor photoelectrode 120 without the electrolyte aqueous solution 140.

It is desirable that the material having a small overvoltage is used for the counter electrode 130. In the first embodiment, as described later, oxygen is generated on the counter electrode 130. A desirable example of the materials of the counter electrode 130 is Pt, Au, Ag, or Fe.

The electrolyte aqueous solution 140 may be acid or alkaline. When a solid electrolyte is disposed between the semiconductor photoelectrode 120 and the counter electrode 130, the electrolyte aqueous solution 140 may be replaced with pure water.

Next, the band structure of the first conductive layer 121, the n-type semiconductor layer 122, and the second conductive layer 123 will be described. FIG. 2A shows a schematic view of the band structure before the first conductive layer 121, the n-type semiconductor layer 122, and the second conductive layer 123 form junctions in the photoelectrochemical cell 100 according to the first embodiment. FIG. 3A shows a schematic view of the band structure after the first conductive layer 121, the n-type semiconductor layer 122 and the second conductive layer 123 have formed junctions in the photoelectrochemical cell 100 according to the first embodiment. In FIG. 2A and FIG. 3A, the vertical axis represents the energy level (unit: eV) on the basis of the vacuum level. In the present specification, the vacuum level is used as the basis with regard to all the energy level.

As shown in FIG. 2A, the band edge level E_{C1} of the conduction band in the first n-type surface region 122-1 is equal to the band edge level E_{CN} of the conduction band in the second n-type surface region 122-N. As shown in FIG. 2B, which will be described later, the band edge level E_{C1} of the conduction band in the first n-type surface region 122-1 may be higher than the band edge level E_{CN} of the conduction band in the second n-type surface region 122-N. For this reason, the band edge level E_{C1} of the conduction band in the first n-type surface region 122-1 is not lower than the band edge level E_{CN} of the conduction band in the second n-type surface region 122-N.

The band edge level E_{V1} of the valence band in the first n-type surface region 122-1 is equal to the band edge level E_{VN} of the valence band in the second n-type surface region 122-N. As shown in FIG. 2B, which will be described later, the band edge level E_{V1} of the valence band in the first n-type surface region 122-1 may be higher than the band edge level E_{VN} of the valence band in the second n-type surface region 122-N. For this reason, the band edge level E_{V1} of the valence band in the first n-type surface region 122-1 is not lower than the band edge level E_{VN} of the valence band in the second n-type surface region 122-N.

The Fermi level E_{FN} of the second n-type surface region 122-N is equal to the Fermi level E_{F1} of the first n-type surface region 122-1. As shown in FIG. 2B, which will be described later, the Fermi level E_{FN} of the second n-type surface region 122-N may be higher than the Fermi level E_{F1} of the first n-type surface region 122-1. For this reason, the Fermi level E_{FN} of the second n-type surface region 122-N is not lower than the Fermi level E_{F1} of the first n-type surface region 122-1.

The Fermi level E_{F1} of the first n-type surface region 122-1 is higher than the Fermi level E_{FC} of the first conductive layer 121. The Fermi level E_{FT} of the second conductive layer 123 is higher than the Fermi level E_{FN} of the second n-type surface region 122-N.

Then, the first conductive layer 121 is joined to the first n-type surface region 122-1. Furthermore, the second n-type surface region 122-N is joined to the second conductive layer 123. After the junctions have formed, carriers migrate such that the Fermi levels are in accord with each other at each interface. As a result, the curve of the band edge as shown in FIG. 3A occurs. Specifically, at the interface between the first conductive layer 121 and the first n-type surface region 122-1, carriers migrate such that the Fermi level of the first conductive layer 121 is in accord with the Fermi level of the first n-type surface region 122-1. Similarly, at the interface between the second n-type surface region 122-N and the second conductive layer 123, carriers migrate such that the Fermi level of the second n-type surface region 122-N is in accord with the Fermi level of the second conductive layer 123. In this way, the curve of the band edge as shown in FIG. 3A occurs. As just described, since all of the following relation formulae (i), (ii), and (iii) are satisfied, electrons and holes are separated from each other efficiently due to the band bending generated in the semiconductor photoelectrode 120.

E_{CN}≦E_{C1} (i)

E_{VN}≦E_{V1} (ii)

E_{FC}<E_{F1}≦E_{FN}<E_{FT} (iii)

After the semiconductor photoelectrode 120 is brought into contact with the electrolyte aqueous solution 140, an ohmic contact is formed at the interface between the first conductive layer 121 and the electrolyte aqueous solution 140, since both the first conductive layer 121 and the electrolyte aqueous solution 140 are conductive materials. Similarly, an ohmic contact is also formed at the interface between the second conductive layer 123 and the electrolyte aqueous solution 140.

As shown in the relation formula (i), the band edge level E_{C1} of the conduction band in the first n-type surface region 122-1 is not lower than the band edge level E_{CN} of the conduction band in the second n-type surface region 122-N. For this reason, no well-type potential occurs in the band edge level of the conduction band in the n-type semiconductor layer 122 after the junction has been formed.

As shown in the relation formula (ii), the band edge level E_{V1} of the valence band in the first n-type surface region 122-1 is not lower than the band edge level E_{VN} of the valence band in the second n-type surface region 122-N. For this reason, no well-type potential occurs in the band edge level of the valence band in the n-type semiconductor layer 122.

As shown in the relation formula (iii), the Fermi level E_{FN} of the second n-type surface region 122-N is not lower than the Fermi level E_{F1} of the first n-type surface region 122-1. For this reason, in the n-type semiconductor layer 122, the curve of the band occurs, but no Schottky barrier is formed. When light reaches the n-type semiconductor layer 122 through the second conductive layer 123, electrons and holes are generated in the n-type semiconductor layer 122 due to photoexcitation. The generated electrons migrate from the n-type semiconductor layer 122 to the second conductive layer 123 along the conduction band to generate hydrogen on the second conductive layer 123. On the other hand, the generated holes migrate from the n-type semiconductor layer 122 to the first conductive layer 121 along the valence band. As just described, since no Schottky barrier is formed, the electrons and holes are not prevented from migrating. For this reason, electrons and holes are separated from each other efficiently to decrease a probability of the recombination of electrons and holes. Accordingly, the quantum efficiency of the reaction for generating hydrogen by irradiating with light is improved.

As shown in the relation formula (iii), since the Fermi level E_{F1} of the first n-type surface region 122-1 is higher than the Fermi level E_{FC} of the first conductive layer 121, the first n-type surface region 122-1 and the first conductive layer 121 form a Schottky barrier. For this reason, the electrons are prevented from migrating from the n-type semiconductor layer 122 to the first conductive layer 121. On the other hand, holes migrate from the n-type semiconductor layer 122 to the first conductive layer 121. As a result, the probability of the recombination of the electrons and the holes is further decreased. The quantum efficiency of the reaction for generating hydrogen by irradiating with light is further improved.

As shown in the relation formula (iii), since the Fermi level E_{FT} of the second conductive layer 123 is higher than the Fermi level E_{FN} of the second n-type surface region 122-N, the n-type semiconductor layer 122 and the second conductive layer 123 form an ohmic contact. On the other hand, holes are prevented from migrating from the n-type semiconductor layer 122 to the second conductive layer 123. In this way, the electrons and the holes generated in the n-type semiconductor layer 122 due to the photoexcitation are separated from each other to further decrease the probability of the recombination. As a result, the quantum efficiency of the reaction for generating hydrogen by irradiating with light is further improved.

In the comparative example 3, which will be described later, the relation E_{FC}<E_{F1} is not satisfied. In the comparative example 3, since the first conductive layer 121 is formed of ITO, E_{FC} is equal to −4.24 eV. Since the first n-type surface region 122-1 is formed of NbON, E_{F1} is equal to −4.44 eV. For this reason, note that the relation of E_{FC}>E_{F1} is satisfied in the comparative example 3.

In the comparative example 4, which will be described later, the relation E_{FN}<E_{FT} is not satisfied. In the comparative example 4, since the second n-type surface region 122-N is formed of Nb₂O₅, E_{FN} is equal to −4.34 eV. Since the second conductive layer 123 is formed of NiO, E_{FT} is equal to −5.04 eV. For this reason, note that the relation of E_{FN}>E_{FT} is satisfied in the comparative example 4.

FIG. 3C shows a schematic view of the band structure after the first conductive layer 121 and the n-type semiconductor layer 122 have been joined to each other in a case where the second conductive layer 123 is not provided. FIG. 3C is also a schematic view of the band structure in the comparative example 6. In this case, the n-type semiconductor layer 122 is in contact with the electrolyte aqueous solution 140. However, the n-type semiconductor layer 122 and the electrolyte aqueous solution 140 form a Schottky barrier. For this reason, as shown in FIG. 3C, a well-type potential is formed in a part of the n-type semiconductor layer 122 near the second conductive layer 123. Accordingly, hydrogen is not generated on the surface of the n-type semiconductor layer 122 even when the n-type semiconductor layer 122 is irradiated with light.

(Composition Gradient)

In FIG. 2A and FIG. 3A, the n-type semiconductor layer 122 is composed of one semiconductor film which does not have a composition gradient. On the other hand, as shown in FIG. 2B and FIG. 3B, the n-type semiconductor layer 122 may be composed of one semiconductor film having a composition gradient.

The n-type semiconductor layer 122 is composed of two or more kinds of elements. The concentration of at least one kind of the element included in the n-type semiconductor layer 122 may be increased or decreased along the thickness direction of the n-type semiconductor layer 122. This is referred to as composition gradient. For example, when the n-type semiconductor layer 122 is formed of one kind of compound, the concentration of at least one kind of the element which constitutes the compound is increased or decreased along the thickness direction of the n-type semiconductor layer 122. The concentration of such an element may be zero at the interface between the n-type semiconductor layer 122 and the first conductive layer 121 or at the interface between the n-type semiconductor layer 122 and the second conductive layer 123.

As just described, the composition of the n-type semiconductor layer 122 may have gradient. Desirably, the composition of the n-type semiconductor layer 122 has monotonical or step-wise gradient. Hereinafter, for ease of explanation, the present inventors suppose that the n-type semiconductor layer 122 is formed by joining a plurality of n-type semiconductor films in which the composition is varied stepwise. The number of the plurality of the n-type semiconductor films is N (where N is a natural number of not lower than 3).

FIG. 2B and FIG. 3B show band structures when the n-type semiconductor layer 122 is formed of the plurality of the n-type semiconductor films in which the composition is varied stepwise. FIG. 2B shows a band structure before the joining. FIG. 3B shows a band structure after the joining. In FIG. 2B and FIG. 3B, the first n-type surface region 122-1 is the first n-type semiconductor film. On the other hand, the second n-type surface region 122-N is the Nth n-type semiconductor film. The n-type semiconductor film interposed between the first n-type surface region 122-1 and the second n-type surface region 122-N is referred to as an intermediate n-type semiconductor film 122-K (where K is a natural number which satisfies 2≦K≦N−1).

As shown in FIG. 2B, the band edge level E_{CK} of the conduction band in the intermediate n-type semiconductor film 122-K is lower than the band edge E_{C1} of the conduction band in the first n-type surface region 122-1. On the other hand, the band edge level E_{CK} is higher than the band edge E_{CN} of the conduction band in the second n-type surface region 122-N. In other words, the following relation formula (iv) is satisfied.

E_{CN}<E_{CK}<E_{C1} (iv)

Similarly, the band edge level E_{VK} of the valence band in the intermediate n-type semiconductor film 122-K is lower than the band edge E_{V1} of the valence band in the first n-type surface region 122-1. On the other hand, the band edge level E_{VK} is higher than the band edge E_{VN} of the valence band in the second n-type surface region 122-N. In other words, the following relation formula (v) is satisfied.

E_{VN}<E_{VK}<E_{V1} (V)

The Fermi level E_{FK} of the intermediate n-type semiconductor film 122-K is higher than the Fermi level E_{F1} of the first n-type surface region 122-1. On the other hand, the Fermi level E_{FK} is lower than the Fermi level E_{FN} of the second n-type surface region 122-N. In other words, the following relation formula (vi) is satisfied.

E_{F1}<E_{FK}<E_{FN} (vi)

The Fermi level E_{F1} of the first n-type surface region 122-1 is higher than the Fermi level E_{FC} of the first conductive layer 121. In other words, the following relation (vii) is satisfied.

E_{FC}<E_{F1} (Vii)

The Fermi level E_{FT} of the second conductive layer 123 is higher than the Fermi level E_{FN} of the second n-type surface region 122-N. In other words, the following relation (viii) is satisfied.

E_{FN}<E_{FT} (Viii)

Next, the junctions are formed. As a result, the curve of the band edge as shown in FIG. 3B occurs. In FIG. 3B, electrons and holes are separated from each other more efficiently due to the band bending generated in the semiconductor photoelectrode 120, since all of the following three relation formulae (ia), (iia), and (iiia) are satisfied.

E_{CN}<E_{CK}<E_{C1} (ia)

E_{VN}<E_{VK}<E_{V1} (iia)

E_{FC}<E_{F1}<E_{FK}<E_{FN}<E_{FT} (iiia)

Unlike in the case shown in FIG. 2A and FIG. 3A, since the n-type semiconductor layer 122 has a composition gradient in its thickness direction, the conduction band also has a composition gradient along its thickness direction. For this reason, the electrons generated in the n-type semiconductor layer 122 migrate to the second conductive layer 123 more efficiently. Similarly, the valence band also has a composition gradient along its thickness direction. For this reason, the holes generated in the n-type semiconductor layer 122 migrate to the first conductive layer 121 more efficiently. In this way, the composition gradient improves the efficiency of the charge separation.

When the electrolyte aqueous solution 140 has a pH of 0 and a temperature of 25 degrees Celsius, it is desirable that the Fermi level E_{FN} of the second n-type surface region 122-N which has been in contact with the electrolyte aqueous solution 140 is not lower than −4.44 eV and that the band edge level E_{V1} of the valence band of the first n-type surface region 122-1 is not higher than −5.67 eV in the first embodiment.

Since the Fermi level E_{FN} of the second n-type surface region 122-N is not lower than −4.44 eV (e.g., −4.43 eV), the electric potential of the second conductive layer 123 is not lower than −4.44 eV. Since the oxidation-reduction potential of hydrogen is −4.44 eV, hydrogen is generated on the second conductive layer 123 efficiently.

Since the band edge level E_{V1} of the valence band of the first n-type surface region 122-1 is not higher than −5.67 eV (e.g., −5.68 eV), the electric potential of the first conductive layer 121 is not higher than −5.67 eV. Since the oxidation-reduction potential of the water is −5.68 eV, water is efficiently oxidized on the surface of the counter electrode 130 connected electrically to the first conductive layer 121 to generate oxygen.

As just described, water is split efficiently, when the Fermi level E_{FN} of the second n-type surface region 122-N is not lower than −4.44 eV and the band edge level E_{V1} of the valence band of the first n-type surface region 122-1 is not higher than −5.67 eV, in the n-type semiconductor layer 122 which is in contact with the electrolyte aqueous solution 140 having a pH of 0 and a temperature of 25 degrees Celsius.

Although the n-type semiconductor layer 122 which satisfies the above-described energy level is shown in the first embodiment, the Fermi level E_{FN} of the second n-type surface region 122-N may be lower than −4.44 eV and the band edge level E_{V1} of the valence band of the first n-type surface region 122-1 may be higher than −5.67 eV. Even in such a case, hydrogen and oxygen can be generated.

The Fermi level and the potential (i.e., band edge level) at the bottom of the conduction band of the n-type semiconductor layer 122 can be calculated using the flat band potential and the carrier concentration. The flat band potential and carrier concentration of a semiconductor can be determined from the Mott-Schottky plot obtained by measurement using a semiconductor that is a measurement object as an electrode.

Furthermore, the Fermi level of the n-type semiconductor layer 122 in the state of being in contact with the electrolyte aqueous solution 140 at a pH of 0 and a temperature of 25 degrees Celsius can be determined by measurement of the Mott-Schottky plot using a semiconductor that is a measurement object as an electrode in the state where the semiconductor photoelectrode is in contact with an electrolyte aqueous solution at a pH of 0 and a temperature of 25 degrees Celsius.

The potential (i.e., band edge level) at the top of the valence band in the n-type semiconductor layer 122 can be calculated using the band gap and the potential at the bottom of the conduction band in the n-type semiconductor layer 122 calculated by the above-mentioned method. Here, the band gap of the n-type semiconductor layer 122 can be obtained from the optical absorption edge to be observed in the measurement of the light absorption spectrum of a semiconductor that is a measurement object.

The Fermi level of the first conductive layer 121 and the second conductive layer 123 can be determined, for example, by photoelectron spectroscopy.

Next, the operation of the photoelectrochemical cell 100 according to the first embodiment will be described.

Light such as sunlight is incident through the light incident part 110a on the second conductive layer 123 included in the semiconductor photoelectrode 120 disposed in the container 110. The light reaches the n-type semiconductor layer 122 through the second conductive layer 123. In a part of the n-type semiconductor layer 122 which has been irradiated with the light, electrons and holes are generated in the conduction band and the valence band, respectively. The generated holes migrate to the first n-type surface region 122-1. On the other hand, the electrons migrate to the second conductive layer 123. In this way, water is split as shown in the following reaction formula (1) on the surface of the counter electrode 130 connected electrically through the conducting wire 150 to the first conductive layer 121 to generate oxygen. On the other hand, the electrons migrate from the second n-type surface region 122-N to the second conductive layer 123. In this way, hydrogen is generated as shown in the following reaction formula (2) on the surface of the second conductive layer 123.

4h⁺+2H₂O→O₂↑+4H⁺ (1)

4e⁻+4H⁺→2H₂↑ (2)

wherein h⁺ represents a hole.

Since the ohmic junction is formed in the second n-type surface region 122-N while the Schottky barrier is formed in the first n-type surface region 122-1, holes and electrons migrate to the first n-type surface region 122-1 and the second n-type surface region 122-N, respectively, without being disturbed. For this reason, the probability of the recombination of the electrons and the holes generated in the n-type semiconductor layer 122 due to photoexcitation is decreased to improve the quantum efficiency of the reaction for generating hydrogen by irradiating with light.

The second n-type surface region 122-N may have a different crystal structure from the first n-type surface region 122-1. Specifically, the n-type semiconductor layer 122 is formed of rutile titanium oxide and anatase titanium oxide. In the first n-type surface region 122-1, the concentration of the anatase titanium oxide is higher than the concentration of the rutile titanium oxide (i.e., anatase-rich). On the other hand, in the second n-type surface region 122-N, the concentration of the rutile titanium oxide is higher than the concentration of the anatase titanium oxide (i.e., rutile-rich). Even in this case, a similar effect to that of the photoelectrochemical cell 100 according to the first embodiment is realized. The n-type semiconductor layer 122 may be formed in such a manner that the concentration of rutile titanium oxide increases from the second n-type surface region 122-N to the first n-type surface region 122-1 and that the concentration of the anatase titanium oxide increases from the first n-type surface region 122-1 to the second n-type surface region 122-N. In this way, each of the conduction band and the valence band of the n-type semiconductor layer 122 has a gradient along the thickness direction of the n-type semiconductor layer 122.

When the n-type semiconductor layer 122 is formed of rutile titanium oxide and anatase titanium oxide, rutile titanium oxide and anatase titanium oxide may contain zirconium, vanadium, niobium, tantalum, chrome, molybdenum, tungsten, manganese, iron, cobalt, copper, silver, zinc, cadmium, gallium, indium, germanium, tin, or antimony as metal ions, unless its crystal structure changes. The phrase “unless its crystal structure changes” means that the relation of the band structure of rutile titanium oxide and anatase titanium oxide (i.e., magnitude relation of the band edge levels of the conduction band and the valence band) does not change. From this viewpoint, the amount of the added metal ions may be not higher than 0.1 atm %, for example.

Even in such a case, since the Fermi level E_{FN} of the second n-type surface region 122-N is required to be higher than the Fermi level E_{F1} of the first n-type surface region 122-1, the Fermi level of titanium oxide needs to be controlled at the time of the formation of the n-type semiconductor layer 122. The Fermi level of titanium oxide may be controlled by changing its crystallinity. The crystallinity may be controlled by changing a film formation condition such as a film formation temperature.

When the first n-type surface region 122-1 and the second n-type surface region 122-N are an anatase-rich titanium oxide film and a rutile-rich titanium oxide film, respectively, by forming the n-type semiconductor layer 122 using titanium oxide, the quantum efficiency is improved.

### Second Embodiment

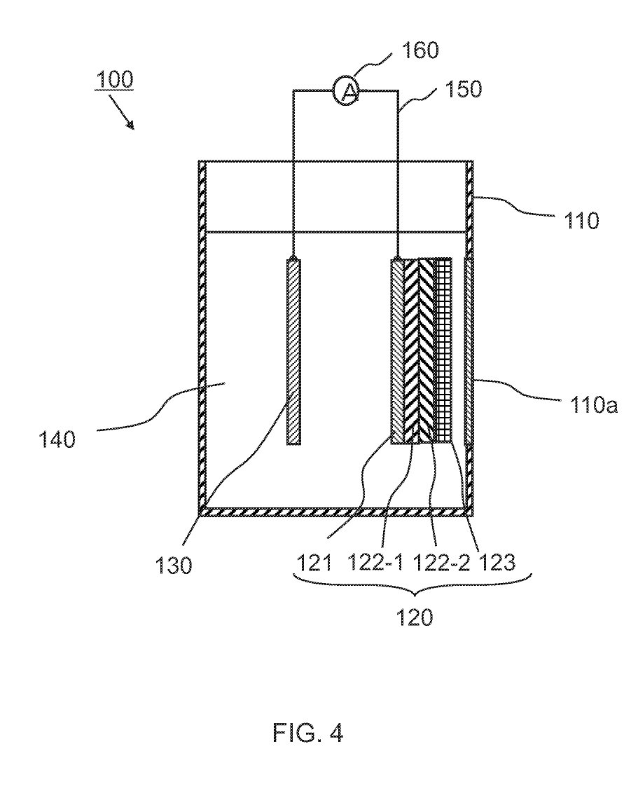

FIG. 4 shows a schematic view of the photoelectrochemical cell 100 according to the second embodiment. In the photoelectrochemical cell 100 according to the second embodiment, the n-type semiconductor layer 122 is composed of two or more n-type semiconductor films. For ease of explanation, the present inventors suppose that the n-type semiconductor layer 122 is composed of two n-type semiconductor films.

As shown in FIG. 4, the n-type semiconductor layer 122 is composed of the first n-type semiconductor film 122-1 and the second n-type semiconductor film 122-2. The second embodiment is substantially the same as the case where N=2 and k=0 in the first embodiment.

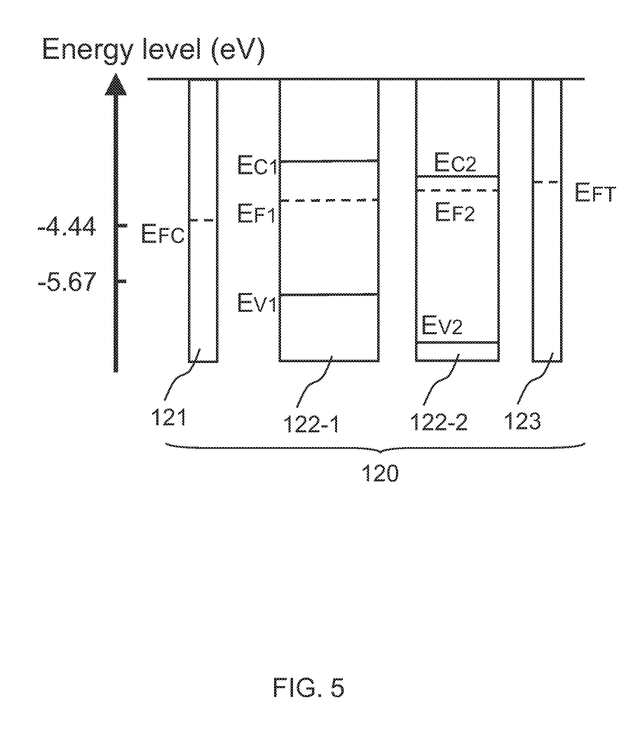

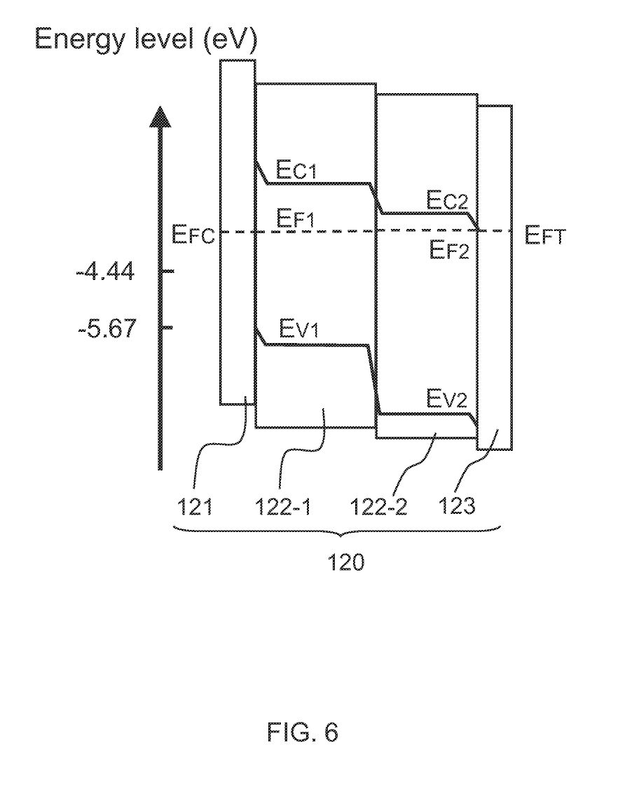

FIG. 5 shows a schematic view of the band structure in the second embodiment before the joining. FIG. 6 shows a schematic view of the band structure in the second embodiment after the joining.

As shown in FIG. 5, the band edge level E_{C1} of the conduction band and the band edge level E_{V1} of the valence band of the first n-type semiconductor film 122-1 are higher than the band edge level E_{C2} of the conduction band and the band edge level E_{V2} of the valence band of the second n-type semiconductor film 122-2, respectively. The Fermi level E_{F2} of the second n-type semiconductor film 122-2 is higher than the Fermi level E_{F1} of the first n-type semiconductor film 122-1.

As shown in FIG. 6, carriers migrate such that the Fermi level of the first n-type semiconductor film 122-1 is in accord with the Fermi level of the second n-type semiconductor film 122-2 at the interface between the first n-type semiconductor film 122-1 and the second n-type semiconductor film 122-2. As a result, the curve of the band edge occurs. Since the following three relation formulae (x)-(xii) are all satisfied, no Schottky barrier is formed at the interface between the first n-type semiconductor film 122-1 and the second n-type semiconductor film 122-2.

E_{C2}<E_{C1} (x)

E_{V2}<E_{V1} (xi)

E_{F1}<E_{F2} (xii)

Similarly to the case where the n-type semiconductor layer 122 has a composition gradient in the first embodiment, the quantum efficiency of reaction for generating hydrogen by irradiating with light is improved in the photoelectrochemical cell 100 according to the second embodiment.

### Third Embodiment

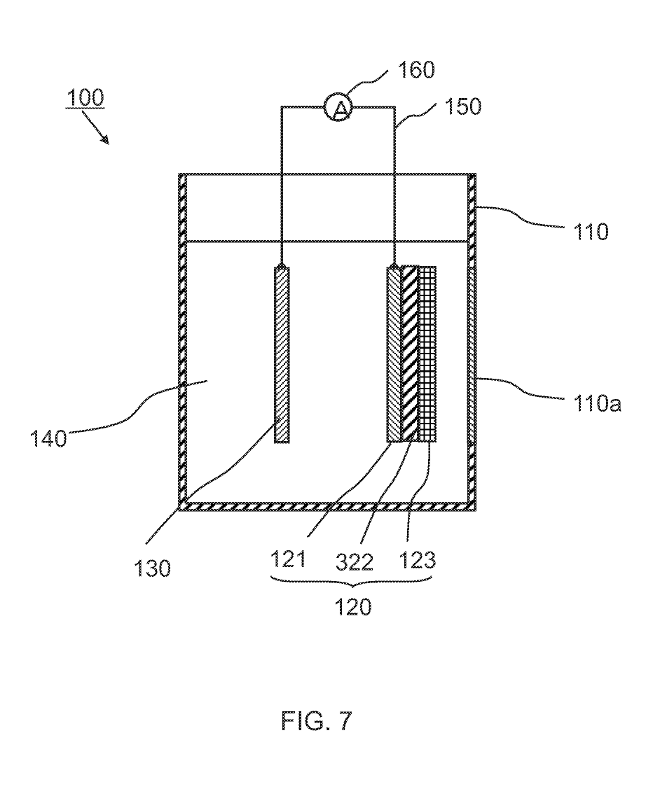

Unlike in the first embodiment, a p-type semiconductor layer 322 is used in the third embodiment. As shown in FIG. 7, in other words, the p-type semiconductor layer 322 is used instead of the n-type semiconductor layer 122. For this reason, the inequality signs described in the first embodiment are reversed in the third embodiment. In other words, the following inequalities are established in the third embodiment,

E_{CN}≧E_{C1} (i)′

E_{VN}≧E_{V1} (ii)′

E_{FC}>E_{F1}≧E_{FN}>E_{FT} (iii)′

E_{CN}>E_{CK}>E_{C1} (iv)′

E_{VN}>E_{VK}>E_{V1} (v)′

E_{F1}>E_{FK}>E_{FN} (vi)′

E_{FC}>E_{F1} (vii)′

E_{FN}>E_{FT} (viii)′

E_{CN}>E_{CK}>E_{C1} (ia)′

E_{VN}>E_{VK}>E_{V1} (iia)′

E_{FC}>E_{F1}>E_{FK}>E_{FN}>E_{FT} (iiia)′

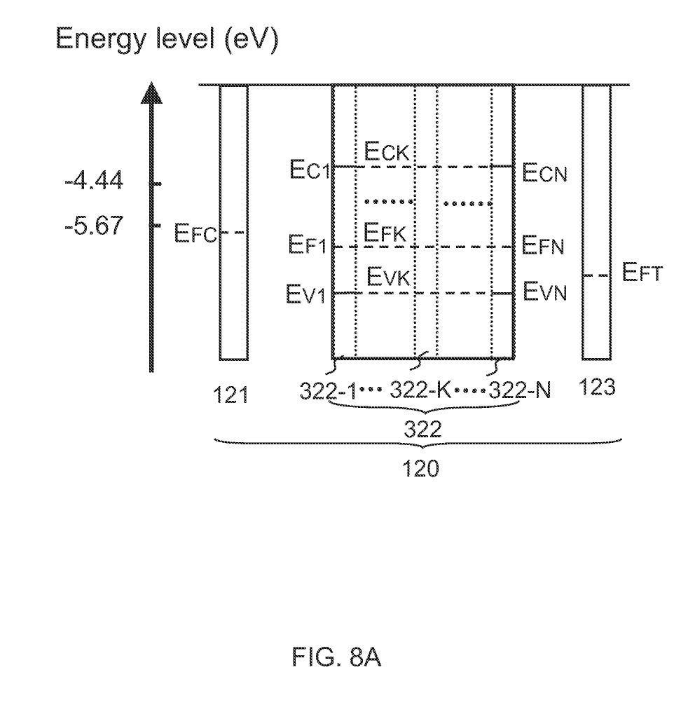

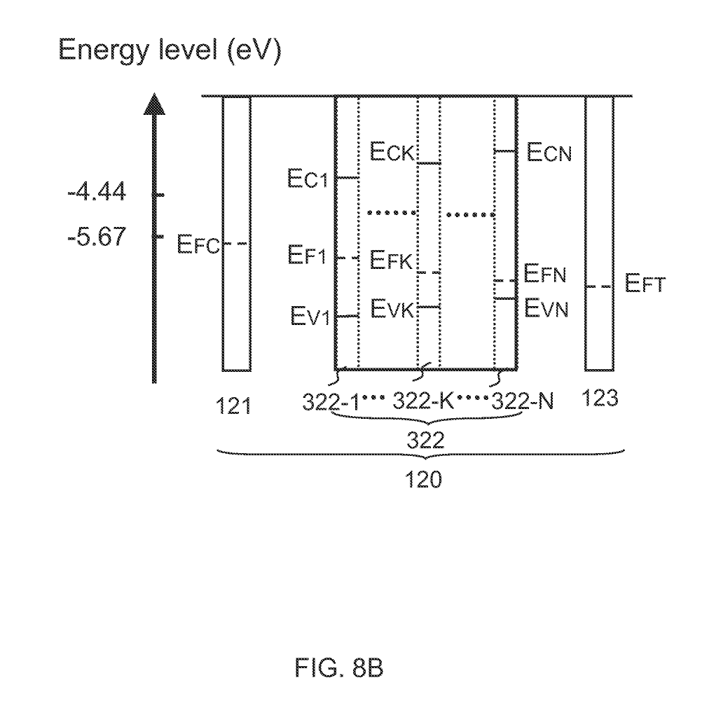

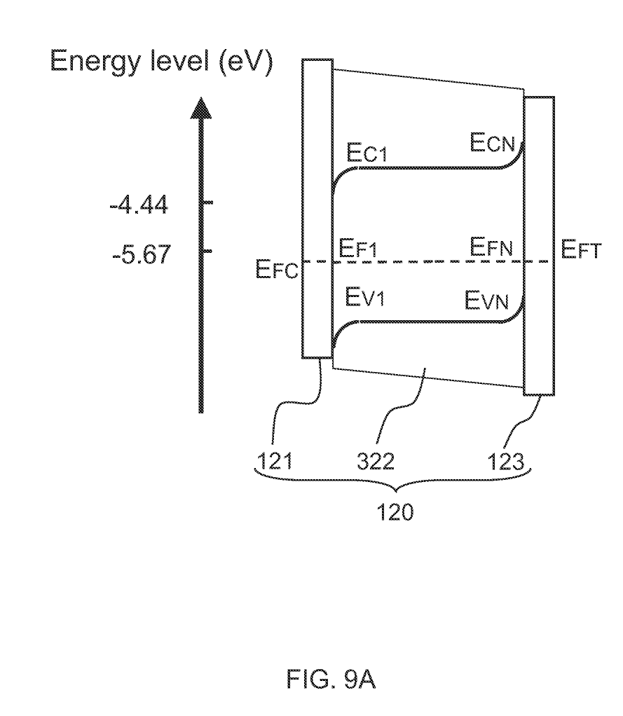

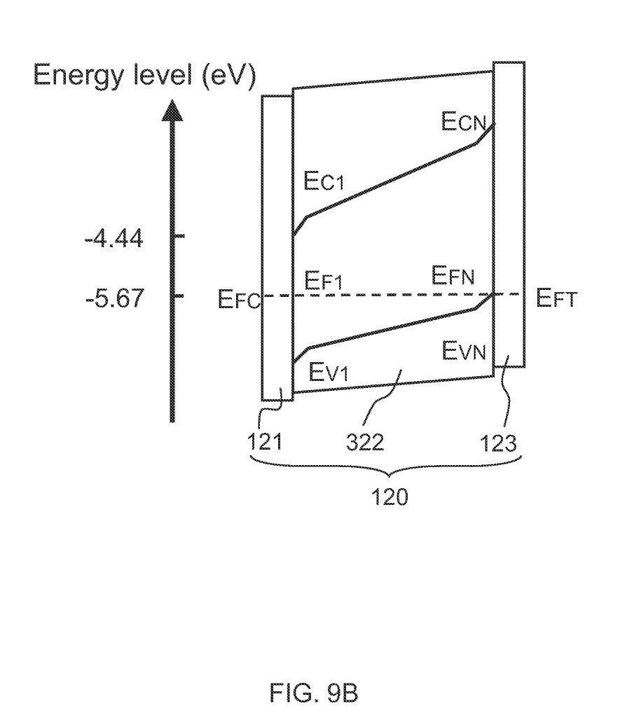

For more detail, see FIG. 8A, FIG. 8B, FIG. 9A, and FIG. 9B. FIG. 8A and FIG. 9A correspond to FIG. 2A and FIG. 3A, respectively. FIG. 8B and FIG. 9B correspond to FIG. 2B and FIG. 3B, respectively. FIG. 8A and FIG. 8B each show a schematic view of the band structure before the joining. FIG. 9A and FIG. 9B each show a schematic view of the band structure after the joining. The p-type semiconductor layer 322 may also have a composition gradient, similarly to the n-type semiconductor layer 122.

Furthermore, the semiconductor photoelectrode 120 including the p-type semiconductor layer 322 functions as an anode electrode. In other words, not hydrogen but oxygen is generated on the second conductive layer 123. On the other hand, the counter electrode 130 functions as a cathode electrode. In other words, not oxygen but hydrogen is generated on the counter electrode 130.

In the third embodiment, an example of the materials of the first conductive layer 121 is a metal or a conductive material. An example of the metal is Ti, Ni, Ta, Nb, Al, or Ag. An example of the conductive material is ITO or FTO. From these materials, the materials capable of forming an ohmic contact together with the p-type semiconductor layer 322 may be selected appropriately.

In the third embodiment, the p-type semiconductor layer 322 is formed of at least one semiconductor selected from the group consisting of an oxide, a sulfide, a selenide, a telluride, a nitride, an oxynitride, and a phosphide. In particular, desirably, the p-type semiconductor layer 322 is formed of a compound including, as a constituent element, at least one kind of element selected from the group consisting of copper, silver, gallium, indium, germanium, tin, and antimony.

In the third embodiment, an example of the material of the second conductive layer 123 is nickel oxide, copper-niobium composition oxide, or copper-strontium composition oxide.

### Fourth Embodiment

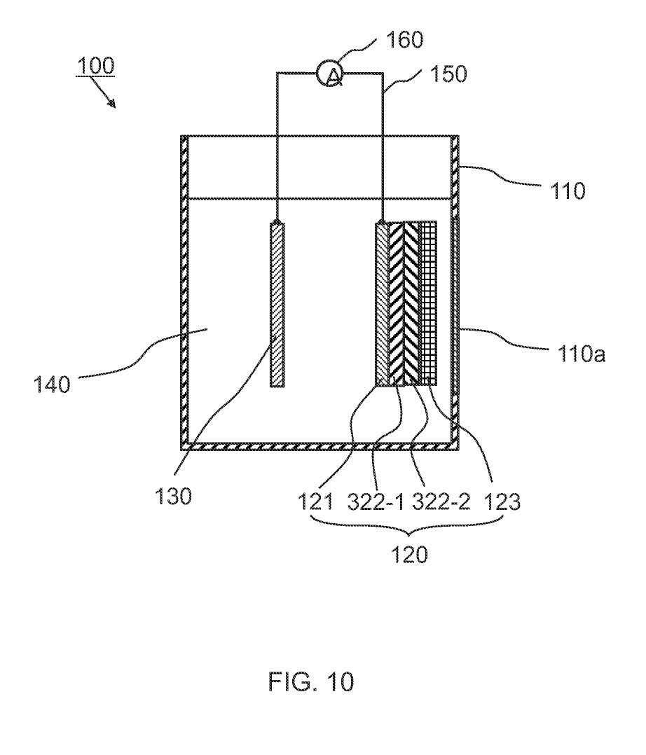

FIG. 10 shows a schematic view of the photoelectrochemical cell 100 according to the fourth embodiment. The photoelectrochemical cell 100 according to the fourth embodiment is the same as the photoelectrochemical cell according to the third embodiment, except that the p-type semiconductor layer 322 is composed of two or more p-type semiconductor films. For ease of explanation, the present inventors suppose that the p-type semiconductor layer 322 is composed of two semiconductor films.

As shown in FIG. 10, the p-type semiconductor layer 322 is composed of a first p-type semiconductor film 322-1 and a second p-type semiconductor film 322-2. The fourth embodiment is substantially the same as the case where N=2 and k=0 in the third embodiment.

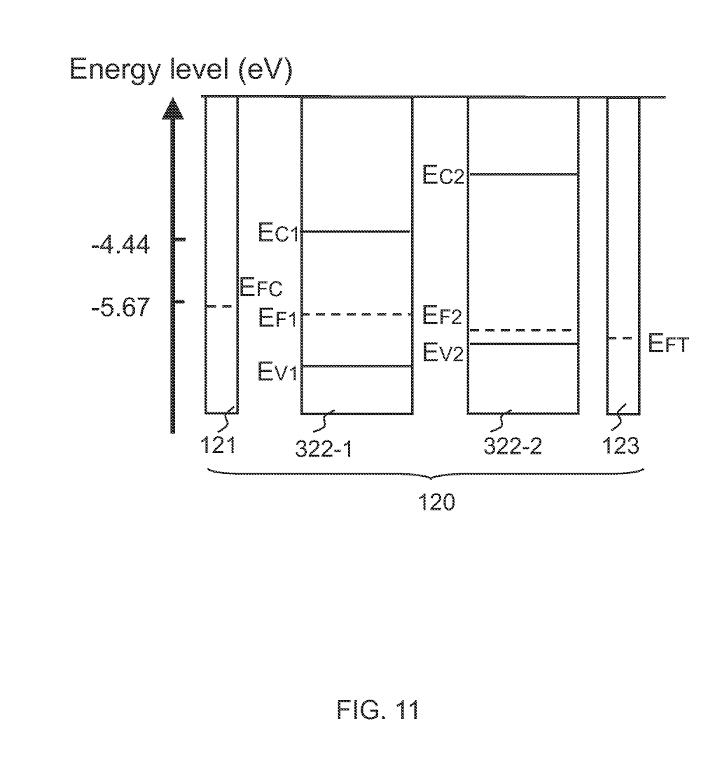

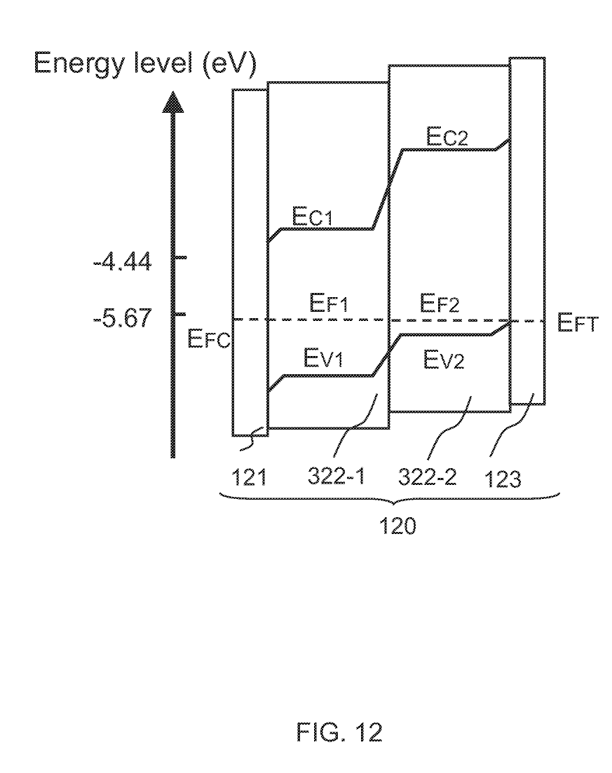

FIG. 11 shows a schematic view of the band structure in the fourth embodiment before the joining. FIG. 12 shows a schematic view of the band structure in the fourth embodiment after the joining.

As shown in FIG. 11, the band edge level E_{C1} of the conduction band and the band edge level E_{V1} of the valence band of the first p-type semiconductor film 322-1 are higher than the band edge level E_{C2} of the conduction band and the band edge level E_{V2} of the valence band of the second p-type semiconductor film 322-2, respectively. The Fermi level E_{F2} of the second p-type semiconductor film 322-2 is higher than the Fermi level E_{F1} of the first p-type semiconductor film 322-1.

As shown in FIG. 12, carriers migrate such that the Fermi level of the first p-type semiconductor film 322-1 is in accord with the Fermi level of the second p-type semiconductor film 322-2 at the interface between the first p-type semiconductor film 322-1 and the second p-type semiconductor film 322-2. As a result, the curve of the band edge occurs. Since the following three relation formulae (x)′-(xii)′ are all satisfied, no Schottky barrier is formed at the interface between the first p-type semiconductor film 322-1 and the second p-type semiconductor film 322-2.

E_{C2}>E_{C1} (x)′

E_{V2}>E_{V1} (xi)′

E_{F1}>E_{F2} (xii)′

Similarly to the case where the p-type semiconductor layer 322 has a composition gradient in the third embodiment, the quantum efficiency of the reaction for generating hydrogen by irradiating with light is improved also in the photoelectrochemical cell according to the fourth embodiment.

### Fifth Embodiment

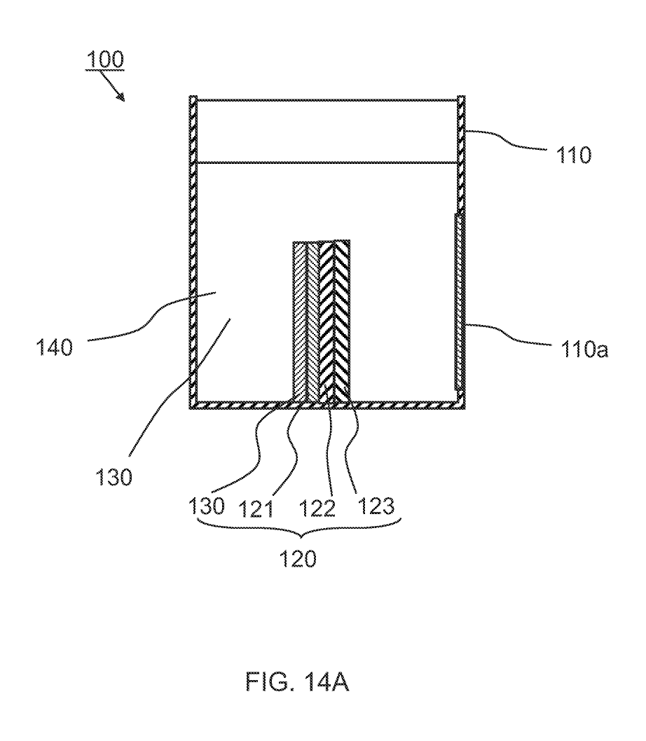

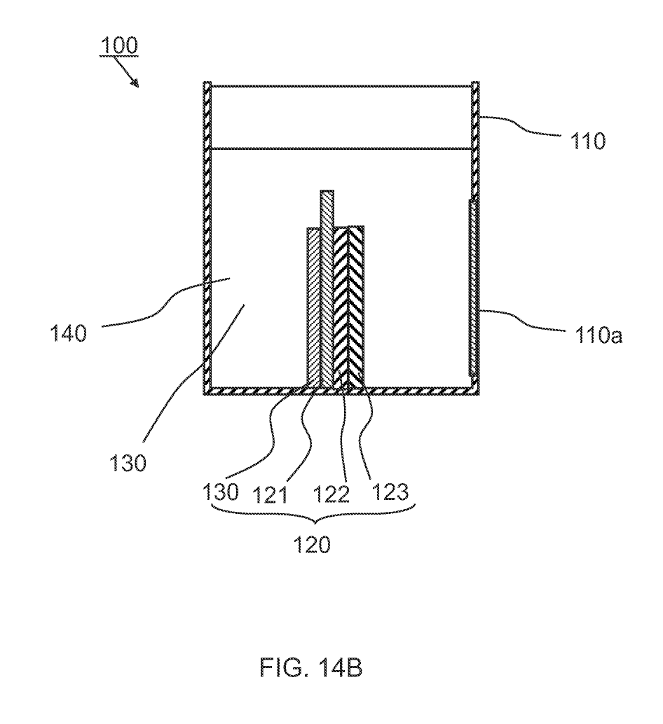

FIG. 14A shows a schematic view of the photoelectrochemical cell 100 according to the fifth embodiment. In the photoelectrochemical cell 100 according to the fifth embodiment, the back surface of the first conductive layer 121 is in contact with the plate-like counter electrode 130. The photoelectrochemical cell 100 according to the fifth embodiment does not need the conducting wire used for electrically connecting the semiconductor photoelectrode 120 to the counter electrode 130. Since the photoelectrochemical cell 100 according to the fifth embodiment does not have resistance loss due to the conducting wire, the quantum efficiency of the reaction for generating hydrogen by irradiating with light is further improved. Furthermore, the semiconductor photoelectrode 120 is electrically connected to the counter electrode 130 easily. As shown in FIG. 14B, a part of the front surface of the first conductive layer 121 may be in contact with the plate-like counter electrode 130. As just described, the part of the first conductive layer 121 may be in contact with the counter electrode 130 in the fifth embodiment.

### Sixth Embodiment

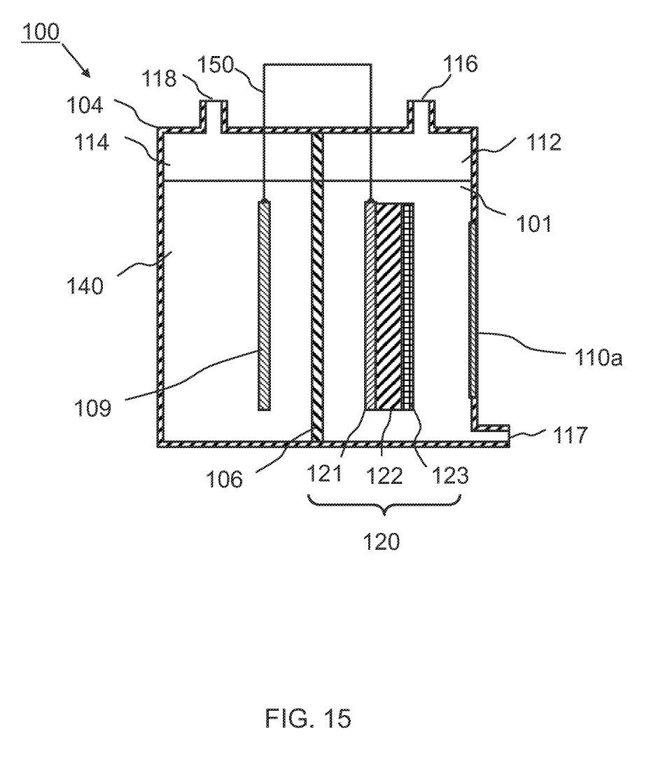

FIG. 15 shows a schematic view of the photoelectrochemical cell 100 according to the sixth embodiment. The photoelectrochemical cell 100 according to the sixth embodiment is the same as the photoelectrochemical cell 100 according to the first embodiment, except that the photoelectrochemical cell 100 is divided into a first chamber 112 and a second chamber 114 by a separator 106. The electrolyte aqueous solution 140 is stored in the first chamber 112 and the second chamber 114. The electrolyte aqueous solution 140 stored in the first chamber 112 may be the same as or different from the electrolyte aqueous solution 140 stored in the second chamber 114.

In the sixth embodiment, the photoelectrochemical cell 100 comprises a first outlet 116, an inlet 117, and a second outlet 118. The first chamber 112 is provided with the first outlet 116, and a gas generated in the first chamber 112 is released through the first outlet 116 to the outside thereof. Similarly, the second chamber 114 is provided with the second outlet 118, and a gas generated in the second chamber 114 is released through the second outlet 118 to the outside thereof. The electrolyte aqueous solution 140 is supplied to the inside of the container 110 through the inlet 117.

Ions contained in the electrolyte aqueous solution 140 can travel through the separator 106. However, the separator 106 prevents the gas generated in the first chamber 112 from being mixed with the gas generated in the second chamber 114. An example of the materials of the separator 106 is a solid electrolyte. An example of the solid electrolyte is a polymer solid electrolyte. An example of the polymer solid electrolyte is an ion exchange membrane such as Nafion (registered trademark). The separator 106 allows oxygen and hydrogen generated in the container 110 to be separated from each other easily.

### Seventh Embodiment

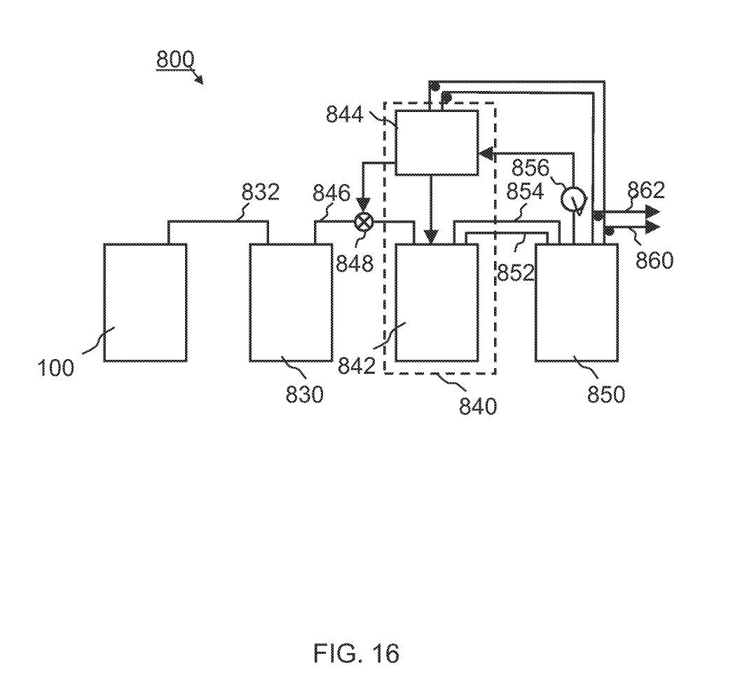

FIG. 16 shows a schematic view of an energy system according to the seventh embodiment. As shown in FIG. 16, an energy system 800 according to the seventh embodiment comprises a photoelectrochemical cell 100 according to the first to sixth embodiments, a hydrogen reservoir 830, a fuel cell 840, and a battery 850. It is desirable that the photoelectrochemical cell 100 according to the sixth embodiment is included in the energy system 800 according to the seventh embodiment. Hereinafter, the present inventors suppose that the photoelectrochemical cell 100 according to the sixth embodiment is included in the energy system 800 according to the seventh embodiment.

The hydrogen reservoir 830 is connected to the first chamber 112 or the second chamber 114 through a first pipe 832. The hydrogen reservoir 830 may comprise a compressor for compressing hydrogen and a high pressure hydrogen cylinder for storing hydrogen compressed by the compressor.

The fuel cell 840 comprises an electric power generation part 842 and a fuel cell control part 844 for controlling the electric power generation part 842. The fuel cell 840 is connected to the hydrogen reservoir 830 through a second pipe 846. The second pipe 846 is provided with an isolation valve 848. An example of the fuel cell 840 is a polymer solid electrolyte fuel cell.

A positive electrode and a negative electrode of the battery 850 are electrically connected to a positive electrode and a negative electrode of the electric power generation part 842 through a first wiring 852 and a second wiring 854, respectively. The battery 850 may be provided with a capacity measurement part 856 for measuring the remaining capacity of the battery 850. An example of the battery 850 is a lithium ion battery.

When the n-type semiconductor layer 122 is used, since hydrogen is generated in the first chamber 112, the first pipe 832 is connected to the first chamber 112 through the first outlet 116. When the p-type semiconductor layer 322 is used, since hydrogen is generated in the second chamber 114, the first pipe 832 is connected to the second chamber 114 through the second outlet 118.

Oxygen thus generated is exhausted to the outside of the photoelectrochemical cell 100. Hydrogen thus generated is supplied into the hydrogen reservoir 830.

When the fuel cell 840 generates electric power, the isolation valve 848 is opened on the basis of the signal transmitted from the fuel cell control part 844 to supply hydrogen stored in the hydrogen reservoir 830 to the electric power generation part 842 through the second pipe 846.

The electric power generated in the electric power generation part 842 is stored in the battery 850 through the first wiring 852 and the second wiring 854. The electric power stored in the battery 850 is supplied to a house or a company through a third wiring 860 and a fourth wiring 862.

Since hydrogen is supplied from the photoelectrochemical cell 100 according to the first to sixth embodiments to the energy system 800 according to the seventh embodiment, the energy system 800 according to the seventh embodiment supplies electric power effficiently.

### EXAMPLES

The present invention will be described in more detail with reference to the following inventive examples and comparative examples.

### Inventive Example 1

In the inventive example 1, the photoelectrochemical cell 100 shown in FIG. 1 was fabricated.

The container 110 was a rectangular glass container having an opening on the upper part thereof. The electrolyte aqueous solution 140 was an H₂SO₄ aqueous solution having a concentration of 1 mol/L.

The semiconductor photoelectrode 120 was fabricated in accordance with the following procedures.

A Pt substrate having a size of 1 cm×1 cm was prepared as the first conductive layer 121. The back surface of the Pt substrate was coated with a fluoroc resin. A source gas was sprayed on this Pt substrate for six hours to form the n-type semiconductor layer 122.

The source gas contained an organic gas obtained by vaporizing a cyclohexane solution containing Tertiary Butylimino Tris(Ethyl Methylamino) Niobium represented by the chemical formula (CH₃)₃CN═Nb(N(CH₃)C₂H₅)₃ at a concentration of 0.1 mol/L under a temperature of 150 degrees Celsius. The partial pressure of the organic gas was 3.38×10⁻⁵ Pa·m³/s (0.2 sccm).

The source gas contained a nitrogen gas. The partial pressure of the nitrogen gas was 1.69×10⁻¹ Pa·m³/s (1000 sccm).

Furthermore, oxygen was mixed with the source gas. At the beginning of the formation of the n-type semiconductor layer 122, the partial pressure of oxygen was 1.69×10⁻⁴ Pa·m³/s (1 sccm). At the end of the formation of the n-type semiconductor layer 122, the partial pressure of oxygen was 1.69×10⁻³ Pa·m³/s (10 sccm). In this way, oxygen was mixed with the source gas, while the partial pressure of the oxygen gas was increased linearly.

The obtained n-type semiconductor layer 122 had a thickness of 100 nanometers. Near the Pt substrate, the n-type semiconductor layer 122 was formed of NbON. In other words, the back surface of the n-type semiconductor layer 122 was formed of NbON. This means that the first n-type surface region 122-1 was formed of NbON. On the other hand, the front surface of the n-type semiconductor layer 122 was formed of Nb₂O₅, since the partial pressure of the oxygen gas was increased linearly. This means that the second n-type surface region 122-N was formed of Nb₂O₅.

Then, an ITO film was formed on the n-type semiconductor layer 122 by a sputtering method. The formed ITO film had a seat resistance of 10 ohm/□. The formed ITO film had a thickness of 150 nanometers. The formed ITO film functioned as the second conductive layer 123. In this way, the semiconductor photoelectrode 120 was fabricated.

The semiconductor photoelectrode 120 was disposed such that the front surface of the second conductive layer 123 faced the light incident part 110a consisting of glass. The counter electrode 130 was a platinum substrate. The first conductive layer 121 was electrically connected to the counter electrode 130 through the conducting wire 150. In this way, the photoelectrochemical cell 100 according to the inventive example 1 was fabricated. The photoelectrochemical cell 100 according to the inventive example 1 had the semiconductor photoelectrode 120 composed of a stacked structure of: the first conductive layer 121 composed of the Pt substrate/the n-type semiconductor layer 122 having the first n-type surface region 122-1 formed of niobium oxynitride represented by the chemical formula NbON and the second n-type surface region 122-N formed of niobium oxide represented by the chemical formula Nb₂O₅/the second conductive layer 123 composed of the ITO film. The first n-type surface region 122-1 was in contact with the first conductive layer 121 composed of the Pt substrate. The second n-type surface region 122-N was in contact with the second conductive layer 123 composed of the ITO film.

Then, the front surface of the second conductive layer 123 was irradiated with light having an intensity of 1 kW/m² to generate a gas on the electrodes. The light was pseudo-sunlight provided using a solar simulator available from SERIC Ltd.

The gas generated on the front surface of the second conductive layer 123 was collected for thirty minutes. The collected gas was subjected to a gas chromatography to analyze the component and production amount of the gas. Furthermore, a photocurrent density flowing between the semiconductor photoelectrode 120 and the counter electrode 130 was measured using an ammeter 160. Apparent quantum efficiency was calculated using the production amount of the gas generated on the front surface of the second conductive layer 123.

As a result of the analysis, the collected gas was hydrogen. In other words, hydrogen was generated on the front surface of the second conductive layer 123 in the inventive example 1. The generation rate of hydrogen was 1.1×10⁻⁷ liter/second. The photocurrent density measured with the ammeter 160 was 0.88 mA/cm². Based on these matters, the present inventors confirmed that water was electrolyzed stoichiometrically.

The apparent quantum efficiency was calculated on the basis of the following mathematical formula.

Apparent Quantum Efficiency={(measured photocurrent density[mA/cm²])/(theoretical photocurrent density[mA/cm²]generated by the sunlight absorbed by the semiconductor material forming the first n-type surface region 122-1)}×100

The theoretical photocurrent density generated by the sunlight absorbed by niobium oxynitride forming the first n-type surface region 122-1 was 12.5 mA/cm². As a result, the apparent quantum efficiency was approximately 7.0% in the inventive example 1.

Furthermore, the front surface of the second conductive layer 123 was irradiated with light for 1,000 hours. The apparent quantum efficiency after 1,000 hours was approximately 6.9%. This means that the n-type semiconductor layer 122 is significantly hardly deteriorated.

The following Table 1 and Table 2 show the result of the inventive example 1. Table 1 and Table 2 also show the results of the inventive example 2 and the comparative example 1 to the comparative example 6, which will be described later.

TABLE 1

| | | | n-type semiconductor layer | | |
|---|---|---|---|---|---|
| | | first | first n-type | second n-type | second |
| | | conductive | semiconductor | semiconductor | conductive |
| | | layer | film | film | layer |
| Inventive | Material | Pt | NbON | Nb₂O₅ | ITO |
| example 1 | composition | | | | |
| | Fermi level | −5.8 eV | −4.44 eV | −4.34 eV | −4.24 eV |
| | Conduction | — | −4.24 eV | −4.36 eV | — |
| | band | | | | |
| | Valence | — | −6.44 eV | −7.64 eV | — |
| | band | | | | |
| Inventive | Material | Pt | NbON | Nb₂O₅ | ITO |
| example 2 | composition | | | | |
| | Fermi level | −5.8 eV | −4.44 eV | −4.34 eV | −4.24 eV |
| | Conduction | — | −4.24 eV | −4.36 eV | — |
| | band | | | | |
| | Valence | — | −6.44 eV | −7.64 eV | — |
| | band | | | | |
| Comparative | Material | None | NbON | Nb₂O₅ | ITO |
| example 1 | composition | | | | |
| | Fermi level | — | −4.44 eV | −4.34 eV | −4.24 eV |
| | Conduction | — | −4.24 eV | −4.36 eV | — |
| | band | | | | |
| | Valence | — | −6.44 eV | −7.64 eV | — |
| | band | | | | |
| Comparative | Material | None | NbON | Nb₂O₅ | ITO |
| example 2 | composition | | | | |
| | Fermi level | — | −4.44 eV | −4.34 eV | −4.24 eV |
| | Conduction | — | −4.24 eV | −4.36 eV | — |
| | band | | | | |
| | Valence | — | −6.44 eV | −7.64 eV | — |
| | band | | | | |
| Comparative | Material | ITO | NbON | Nb₂O₅ | ITO |
| example 3 | composition | | | | |
| | Fermi level | −4.24 eV | −4.44 eV | −4.34 eV | −4.24 eV |
| | Conduction | — | −4.24 eV | −4.36 eV | — |
| | band | | | | |
| | Valence | — | −6.44 eV | −7.64 eV | — |
| | band | | | | |
| Comparative | Material | Pt | NbON | Nb₂O₅ | NiO |
| example 4 | composition | | | | |
| | Fermi level | −5.8 eV | −4.44 eV | −4.34 eV | −5.04 eV |
| | Conduction | — | −4.24 eV | −4.36 eV | — |
| | band | | | | |
| | Valence | — | −6.44 eV | −7.64 eV | — |
| | band | | | | |
| Comparative | Material | Pt | Nb₂O₅ | NbON | ITO |
| example 5 | composition | | | | |
| | Fermi level | −5.8 eV | −4.34 eV | −4.44 eV | −4.24 eV |
| | Conduction | — | −4.36 eV | −4.24 eV | — |
| | band | | | | |
| | Valence | — | −7.64 eV | −6.44 eV | — |
| | band | | | | |
| Comparative | Material | Pt | NbON | Nb₂O₅ | — |
| example 6 | composition | | | | |
| | Fermi level | −5.8 eV | −4.34 eV | −4.44 eV | — |
| | Conduction | — | −4.36 eV | −4.24 eV | — |
| | band | | | | |
| | Valence | — | −7.64 eV | −6.44 eV | — |
| | band | | | | |

TABLE 2

| | Hydrogen | Measured | Theoretical | | |
|---|---|---|---|---|---|
| | generation | photocurrent | photocurrent | Apparent quantum efficiency | |
| | speed | density | density | At initial | 1,000 |
| | (liter/second) | (mA/cm²) | (mA/cm²) | stage | hours later |
| Inventive | 1.1 × 10⁻⁷ | 0.88 | 12.5 | 7.0% | 6.9% |
| example 1 | | | | | |
| Inventive | 9.0 × 10⁻⁸ | 0.70 | | 5.6% | 5.5% |
| example 2 | | | | | |
| Comparative | 1.1 × 10⁻⁷ | 0.90 | | 7.2% | 5.4% |
| example 1 | | | | | |
| Comparative | 9.1 × 10⁻⁸ | 0.71 | | 7.2% | 5.4% |
| example 2 | | | | | |
| Comparative | 0 | 0 | | Under | not |
| example 3 | | | | measurement | measured |
| | | | | limit | |
| Comparative | 0 | 0 | | Under | not |
| example 4 | | | | measurement | measured |
| | | | | limit | |
| Comparative | 0 | 0 | | Under | not |
| example 5 | | | | measurement | measured |
| | | | | limit | |
| Comparative | 0 | 0 | | Under | not |
| example 6 | | | | measurement | measured |
| | | | | limit | |

### Inventive Example 2

In the inventive example 2, an experiment similar to that in the inventive example 1 was performed, except that the n-type semiconductor layer 122 was composed of two semiconductor films: the first n-type semiconductor film 122-1 and the second n-type semiconductor film 122-2. In other words, in the inventive example 2, the photoelectrochemical cell 100 shown in FIG. 4 was fabricated.

First, a source gas (hereinafter, referred to as “first source gas”) was sprayed on the Pt substrate for four hours to form the first n-type semiconductor film 122-1.

The first source gas contained an organic gas obtained by vaporizing a cyclohexane solution containing Tertiary Butylimino Tris(Ethyl Methylamino) Niobium represented by the chemical formula (CH₃)₃CN═Nb(N(CH₃)C₂H₅)₃ at a concentration of 0.1 mol/L under a temperature of 150 degrees Celsius. The partial pressure of the organic gas was 3.38×10⁻⁵ Pa·m³/s (0.2 sccm).

The first source gas contained a nitrogen gas. The partial pressure of the nitrogen gas was 1.69×10⁻¹ Pa·m³/s (1000 sccm).

The first source gas further contained an oxygen gas. The partial pressure of the oxygen gas was 1.69×10⁻⁴ Pa·m³/s (1 sccm). While the first n-type semiconductor film 122-1 was formed, the partial pressure of the oxygen gas was not changed. In other words, while the first n-type semiconductor film 122-1 was formed, the partial pressure of the oxygen gas was maintained at a constant value of 1.69×10⁻⁴ Pa·m³/s (1 sccm).

In this way, the first n-type semiconductor film 122-1 formed of niobium oxynitride represented by the chemical formula NbON was formed. The formed first n-type semiconductor film 122-1 had a thickness of 60 nanometers.

Then, another source gas (hereinafter, referred to as “second source gas”) was sprayed for two hours to form the second n-type semiconductor film 122-2 on the first n-type semiconductor film 122-1.

The second source gas contained a nitrogen gas. The partial pressure of the nitrogen gas was 1.69×10⁻¹ Pa·m³/s (1000 sccm).

The second source gas further contained an oxygen gas. The partial pressure of the oxygen gas was 1.69×10⁻³ Pa·m³/s (10 sccm). When the second n-type semiconductor film 122-2 was formed, the partial pressure of the oxygen gas was not varied. In other words, while the second n-type semiconductor film 122-2 was formed, the partial pressure of the oxygen gas was maintained at a constant value of 1.69×10⁻³ Pa·m³/s (10 sccm).

In this way, the second n-type semiconductor film 122-2 formed of niobium oxide represented by the chemical formula Nb₂O₅ was formed. The formed second n-type semiconductor film 122-2 had a thickness of 40 nanometers.

Then, an ITO film was formed on the second n-type semiconductor film 122-2 by a sputtering method. The formed ITO film had a seat resistance of 10 ohm/□. The formed ITO film had a thickness of 150 nanometers. The formed ITO film functioned as the second conductive layer 123. In this way, the semiconductor photoelectrode 120 was fabricated. Next, the photoelectrochemical cell 100 according to the inventive example 2 was fabricated using this semiconductor photoelectrode 120. The photoelectrochemical cell 100 according to the inventive example 2 had the semiconductor photoelectrode 120 composed of a stacked structure of: the first conductive layer 121 composed of the Pt substrate/the first n-type semiconductor film 122-1 formed of niobium oxynitride represented by the chemical formula NbON/the second n-type semiconductor film 122-2 formed of niobium oxide represented by the chemical formula Nb₂O₅/the second conductive layer 123 composed of the ITO film.

Similarly to the case of inventive example 1, the front surface of the second conductive layer 123 was irradiated with light having an intensity of 1 kW/m² to generate a gas on the electrodes. The result is shown in Table 1.

### Comparative Example 1

In the comparative example 1, an experiment similar to that in the inventive example 1 was performed, except that the first conductive layer 121 was not provided. In other words, in the comparative example 1, the second conductive layer 123 was formed on the second n-type surface region 122-N formed of niobium oxide represented by the chemical formula Nb₂O₅; however, the first conductive layer 121 was not formed on the first n-type surface region 122-1 formed of niobium oxynitride represented by the chemical formula NbON. At the time of the hydrogen generation, the first n-type surface region 122-1 formed of niobium oxynitride was in contact with the electrolyte aqueous solution 140.

The semiconductor photoelectrode 120 according to the comparative example 1 was fabricated as below.

First, a glass substrate having a size of 1 cm×1 cm was prepared instead of the first conductive layer 121. An ITO film was formed on the front surface of this glass substrate by a sputtering method. The formed ITO film had a seat resistance of 10 ohm/□. The formed ITO film had a thickness of 150 nanometers. The formed ITO film functioned as the second conductive layer 123.

Then, the n-type semiconductor layer 122 was formed on the ITO film similarly to the n-type semiconductor layer 122 according to the inventive example 1, except that the partial pressure of oxygen was 1.69×10⁻³ Pa·m³/s (10 sccm) at the beginning of the formation of the n-type semiconductor layer 122, and that the partial pressure of oxygen was 1.69×10⁻⁴ Pa·m³/s (1 sccm) at the end of the formation of the n-type semiconductor layer 122. In this way, obtained was the semiconductor photoelectrode 120 composed of the stacked structure of: the n-type semiconductor layer 122 having the first n-type surface region 122-1 consisting of niobium oxynitride represented by the chemical formula NbON and the second n-type surface region 122-N consisting of niobium oxide represented by the chemical formula Nb₂O₅/the second conductive layer 123 composed of the ITO film. The second n-type surface region 122-N was joined on the second conductive layer 123 composed of the ITO film. The second conductive layer 123 was electrically connected to the counter electrode 130 through the conducting wire 150.

The back surface of the glass substrate was irradiated with light having an intensity of 1 kW/m². As a result, hydrogen was generated on the counter electrode 130. At the same time, oxygen was generated on the back surface of the second n-type surface region 122-N consisting of niobium oxide represented by the chemical formula Nb₂O₅. The result is shown in Table 1.

As shown in Table 1, the apparent quantum efficiency at the initial stage was a high value of 7.2%; however, the apparent quantum efficiency after 1,000 hours was a low value of 5.4%. The semiconductor photoelectrode 120 according to the comparative example 1 was analyzed in detail. As a result, the first n-type surface region 122-1 which had been formed of NbON and was in contact with the electrolyte aqueous solution 140 was oxidized to Nb₂O₅.

### Comparative Example 2

In the comparative example 2, an experiment similar to that in the inventive example 2 was performed, except that the first conductive layer 121 was not provided. In other words, in the comparative example 2, the second conductive layer 123 was formed on the second n-type semiconductor film 122-2 formed of niobium oxide represented by the chemical formula Nb₂O₅; however, the first conductive layer 121 was not formed on the first n-type semiconductor film 122-1 formed of niobium oxynitride represented by the chemical formula NbON. At the time of the hydrogen generation, the first n-type semiconductor film 122-1 formed of niobium oxynitride was in contact with the electrolyte aqueous solution 140.

The semiconductor photoelectrode 120 according to the comparative example 2 was fabricated as below.

First, a glass substrate having a size of 1 cm×1 cm was prepared instead of the first conductive layer 121. An ITO film was formed on the front surface of this glass substrate by a sputtering method. The formed ITO film had a seat resistance of 10 ohm/□. The formed ITO film had a thickness of 150 nanometers. The formed ITO film functioned as the second conductive layer 123.

Then, the second source gas was sprayed on the ITO film similarly to the case of the second n-type semiconductor film 122-2 according to the inventive example 2 to form the second n-type semiconductor film 122-2. Subsequently, the first source gas was sprayed on the second n-type semiconductor film 122-2 similarly to the case of the first n-type semiconductor film 122-1 according to the inventive example 2 to form the first n-type semiconductor film 122-1. In this way, the semiconductor photoelectrode 120 according to the comparative example 2 was provided. The semiconductor photoelectrode 120 according to the comparative example 2 was composed of the stacked structure of: first n-type semiconductor film 122-1 formed of niobium oxynitride represented by the chemical formula NbON/the second n-type semiconductor film 122-2 formed of niobium oxide represented by the chemical formula Nb₂O₅/the ITO film/the glass substrate. The second conductive layer 123 was electrically connected to the counter electrode 130 through the conducting wire 150.

The back surface of the glass substrate was irradiated with light having an intensity of 1 kW/m². As a result, a gas was generated on the counter electrode 130. At the same time, oxygen was generated on the back surface of the second n-type surface region 122-N consisting of niobium oxide represented by the chemical formula Nb₂O₅. The result is shown in Table 1.

As shown in Table 1, the apparent quantum efficiency at the initial stage was a value of 5.7%; however, the apparent quantum efficiency after 1,000 hours was a low value of 4.3%. The semiconductor photoelectrode 120 according to the comparative example 2 was analyzed in detail. As a result, similarly to the case of the comparative example 1, the first n-type semiconductor film 122-1 which had been formed of NbON and was in contact with the electrolyte aqueous solution 140 was oxidized to Nb₂O₅.

### Comparative Example 3

In the comparative example 3, an experiment similar to that in the inventive example 2 was performed, except that the first conductive layer 121 was an ITO film.

The semiconductor photoelectrode 120 according to the comparative example 3 was fabricated as below.

First, a glass substrate was prepared. Then, a first ITO film was formed on the front surface of this glass substrate by a sputtering method. The formed first ITO film had a seat resistance of 10 ohm/□. The formed first ITO film had a thickness of 150 nanometers. This first ITO film was formed as the first conductive layer 121.

The first source gas was sprayed on the first ITO film similarly to the case of the first n-type semiconductor film 122-1 according to the inventive example 2 to form the first n-type semiconductor film 122-1 formed of niobium oxynitride represented by the chemical formula NbON. Then, the second source gas was sprayed on the first n-type semiconductor film 122-1 similarly to the case of the second n-type semiconductor film 122-2 according to the inventive example 2 to form the second n-type semiconductor film 122-2 formed of niobium oxide represented by the chemical formula Nb₂O₅. Finally, a second ITO film was formed on the second n-type semiconductor film 122-2 by a sputtering method. The formed second ITO film had a seat resistance of 10 ohm/□. The formed second ITO film had a thickness of 150 nanometers. The formed second ITO film functioned as the second conductive layer 123.

In this way, the semiconductor photoelectrode 120 according to the comparative example 3 was provided. The semiconductor photoelectrode 120 according to the comparative example 3 was composed of the stacked structure of: the glass substrate/the first conductive layer 121 composed of the first ITO film/the first n-type semiconductor film 122-1 formed of niobium oxynitride represented by the chemical formula NbON/the second n-type semiconductor film 122-2 formed of niobium oxide represented by the chemical formula Nb₂O₅/the second conductive layer 123 composed of the second ITO film. The first conductive layer 121 composed of the first ITO film was electrically connected to the counter electrode 130 through the conducting wire 150.

The back surface of the glass substrate was irradiated with light having an intensity of 1 kW/m²; however, no gas was generated. The measured photocurrent density was substantially equal to 0. In other words, the photocurrent density was not measured. This reason is described below. A Schottky barrier was formed at the interface between the first conductive layer 121 composed of the first ITO film and the first n-type semiconductor film 122-1 formed of niobium oxynitride represented by the chemical formula NbON. This Schottky barrier generated an inverted well potential in the first n-type semiconductor film 122-1 formed of niobium oxynitride represented by the chemical formula NbON. As a result, electrons and holes generated by irradiating with light were recombined.

### Comparative Example 4

In the comparative example 4, an experiment similar to that in the inventive example 2 was performed, except that the second conductive layer 123 was a NiO film.

The semiconductor photoelectrode 120 according to the comparative example 4 was fabricated as below.

First, a Pt substrate was prepared. This Pt substrate functioned as the first conductive layer 121. Then, the first source gas was sprayed on the front surface of this Pt substrate similarly to the case of the first n-type semiconductor film 122-1 according to the inventive example 2 to form the first n-type semiconductor film 122-1 formed of niobium oxynitride represented by the chemical formula NbON. Then, the second source gas was sprayed on the first n-type semiconductor film 122-1 similarly to the case of the second n-type semiconductor film 122-2 according to the inventive example 2 to form the second n-type semiconductor film 122-2 formed of niobium oxide represented by the chemical formula Nb₂O₅. Finally, a NiO film was formed on the second n-type semiconductor film 122-2 by a sputtering method. The formed NiO film had a seat resistance of 10 ohm/□. The formed NiO film had a thickness of 20 nanometers. The formed NiO film functioned as the second conductive layer 123.

In this way, the semiconductor photoelectrode 120 according to the comparative example 4 was provided. The semiconductor photoelectrode 120 according to the comparative example 4 was composed of the stacked structure of: the first conductive layer 121 composed of the Pt substrate/the first n-type semiconductor film 122-1 formed of niobium oxynitride represented by the chemical formula NbON/the second n-type semiconductor film 122-2 formed of niobium oxide represented by the chemical formula Nb₂O₅/the second conductive layer 123 composed of the NiO film. The first conductive layer 121 composed the Pt substrate was electrically connected to the counter electrode 130 through the conducting wire 150.

Similarly to the case of the inventive example 1, the front surface of the second conductive layer 123 was irradiated with light having an intensity of 1 kW/m²; however, no gas was generated. The measured photocurrent density was substantially equal to 0. In other words, the photocurrent density was not measured. This reason is described below.

A Schottky barrier was formed at the interface between the second conductive layer 123 composed of the NiO film and the second n-type semiconductor film 122-2 formed of niobium oxide represented by the chemical formula Nb₂O₅. This Schottky barrier generated a well-type potential in the second n-type semiconductor film 122-2 formed of niobium oxide represented by the chemical formula Nb₂O₅. As a result, electrons and holes generated by irradiating with light were recombined.

### Comparative Example 5

In the comparative example 5, an experiment similar to that in the inventive example 2 was performed, except that the first n-type semiconductor film 122-1 was formed of niobium oxide represented by the chemical formula Nb₂O₅ and that the second n-type semiconductor film 122-2 was formed of niobium oxynitride represented by the chemical formula NbON. Note that the positional relation between the niobium oxynitride film and the niobium oxide film in the comparative example 5 was inverted with regard to the positional relation therebetween in the inventive example 2.

The semiconductor photoelectrode 120 according to the comparative example 5 was fabricated as below.

First, a Pt substrate was prepared similarly to the case of the inventive example 2. This Pt substrate functioned as the first conductive layer 121. Then, the second source gas was sprayed on the front surface of this Pt substrate similarly to the case of the second n-type semiconductor film 122-2 according to the inventive example 2 to form the first n-type semiconductor film 122-1 formed of niobium oxide represented by the chemical formula Nb₂O₅. Subsequently, the first source gas was sprayed on the first n-type semiconductor film 122-1 similarly to the case of the first n-type semiconductor film 122-1 according to the inventive example 2 to form the second n-type semiconductor film 122-2 formed of niobium oxynitride represented by the chemical formula NbON. Finally, an ITO film was formed on the second n-type semiconductor film 122-2 by a sputtering method.

In this way, the semiconductor photoelectrode 120 was provided. Specifically, the semiconductor photoelectrode 120 according to the comparative example 5 was composed of the stacked structure of: the first conductive layer 121 composed of the Pt substrate/the first n-type semiconductor film 122-1 formed of niobium oxide represented by the chemical formula Nb₂O₅/the second n-type semiconductor film 122-2 formed of niobium oxynitride represented by the chemical formula NbON/the second conductive layer 123 composed of the ITO film. Note that, unlike in the case of the inventive example 2, the first n-type semiconductor film 122-1 and the second n-type semiconductor film 122-2 were formed of Nb₂O₅ and NbON, respectively. The first conductive layer 121 composed of the Pt substrate was electrically connected to the counter electrode 130 through the conducting wire 150.

Similarly to the case of the inventive example 1, the front surface of the second conductive layer 123 was irradiated with light having an intensity of 1 kW/m²; however, no gas was generated. The measured photocurrent density was substantially equal to 0. In other words, the photocurrent density was not measured. This reason is described as below.

A well-type potential occurred in the first n-type semiconductor film 122-1 formed of niobium oxide represented by the chemical formula Nb₂O₅. An inverted well potential occurred in the second n-type semiconductor film 122-2 formed of niobium oxynitride represented by the chemical formula NbON. For this reason, electrons and holes generated by irradiating with light were recombined.

### Comparative Example 6

In the comparative example 6, an experiment similar to that in the inventive example 2 was performed, except that the second conductive layer 123 was not formed. In other words, the semiconductor photoelectrode according to the comparative example 6 was composed of the stacked structure of: the first conductive layer 121 composed of the Pt substrate/the first n-type semiconductor film 122-1 formed of niobium oxynitride represented by the chemical formula NbON/the second n-type semiconductor film 122-2 formed of niobium oxide represented by the chemical formula Nb₂O₅.

Similarly to the case of the inventive example 1, the front surface of the second conductive layer 123 was irradiated with light having an intensity of 1 kW/m²; however, no gas was generated. The measured photocurrent density was substantially equal to 0. In other words, the photocurrent density was not measured. This reason is described as below.

As shown in FIG. 3C, the second n-type semiconductor film 122-2 and the electrolyte aqueous solution 140 form a Schottky barrier. For this reason, a well-type potential was formed at a part of the second n-type semiconductor film 122-2 near the second conductive layer 123. Accordingly, even when the n-type semiconductor layer 122 was irradiated with light, no hydrogen was generated. Electrons and holes generated by irradiating with light were recombined.

### INDUSTRIAL APPLICABILITY

The photoelectrochemical cell according to the present invention has high efficiency of the reaction for splitting water by irradiating with light. Furthermore, high quantum efficiency is maintained for a long time in the photoelectrochemical cell according to the present invention. Hydrogen is provided using such a photoelectrochemical cell. The provided hydrogen can be used for a fuel cell.

### REFERENTIAL SIGNS LIST

100 photoelectrochemical cell
106 separator
112 first chamber
114 second chamber
116 first outlet
117 inlet
118 second outlet
120 semiconductor photoelectrode
121 first conductive layer
122 n-type semiconductor layer
122-1 first n-type surface region or first n-type semiconductor film
122-2 second n-type semiconductor film
122-N second n-type surface region
322 p-type semiconductor layer
322-1 first p-type surface region or first p-type semiconductor film
322-2 second p-type semiconductor film
322-N second p-type surface region
123 second conductive layer
110 container
110a light incident part
130 counter electrode
140 electrolyte aqueous solution
150 conducting wire
800 energy system
830 hydrogen reservoir
840 fuel cell
844 fuel cell control part
850 battery

1. A photoelectrochemical cell, comprising:
a semiconductor photoelectrode which functions as a cathode electrode;
a counter electrode which functions as an anode electrode;
an electrolyte aqueous solution which is in contact with surfaces of the semiconductor photoelectrode and the counter electrode; and
a container containing the semiconductor photoelectrode, the counter electrode, and the electrolyte aqueous solution, wherein
the semiconductor photoelectrode includes:
a first conductive layer;
an n-type semiconductor layer disposed on the first conductive layer; and
a second conductive layer which completely covers a surface of the n-type semiconductor layer;
the n-type semiconductor layer has a first n-type surface region and a second n-type surface region;
the first n-type surface region is in contact with the first conductive layer;
the second n-type surface region is in contact with the second conductive layer;
a band edge level E_{C1} of a conduction band in the first n-type surface region is not lower than a band edge level E_{CN} of a conduction band in the second n-type surface region;
a band edge level E_{V1} of a valence band in the first n-type surface region is not lower than a band edge level E_{VN} of a valence band in the second n-type surface region;
a Fermi level E_{FN} of the second n-type surface region is not lower than a Fermi level E_{F1} of the first n-type surface region;
the Fermi level E_{F1} of the first n-type surface region is higher than a Fermi level E_{FC} of the first conductive layer;
a Fermi level E_{FT} of the second conductive layer is higher than the Fermi level E_{FN} of the second n-type surface region;
the counter electrode is electrically connected to the first conductive layer;
the second conductive layer is light-transmissive; and
the second conductive layer functions as a light incident surface.

2. The photoelectrochemical cell according to claim 1, wherein
the n-type semiconductor layer is composed of two or more kinds of elements; and
a concentration of the at least one kind of the element included in the n-type semiconductor layer is increased or decreased along a thickness direction of the n-type semiconductor layer.

3. The photoelectrochemical cell according to claim 1, wherein
the n-type semiconductor layer is formed of at least one kind of semiconductor selected from the group consisting of an oxide semiconductor, a nitride semiconductor, and an oxynitride semiconductor.

4. The photoelectrochemical cell according to claim 1, wherein
the n-type semiconductor layer is composed of a first n-type semiconductor film and a second n-type semiconductor film;
the first n-type semiconductor film is disposed on the first conductive layer;
the second n-type semiconductor film is disposed between the first n-type semiconductor film and the second conductive layer,
a band edge level of a conduction band in the first n-type semiconductor film is not lower than a band edge level of a conduction band in the second n-type semiconductor film;
a band edge level of a valence band in the first n-type semiconductor film is not lower than a band edge level of a valence band in the second n-type semiconductor film;
a Fermi level of the second n-type semiconductor film is higher than a Fermi level of the first n-type semiconductor film;
a Fermi level of the first n-type semiconductor film is higher than a Fermi level of the first conductive layer; and
a Fermi level of the second conductive layer is higher than a Fermi level of the second n-type semiconductor film.

5. The photoelectrochemical cell according to claim 4, wherein
the second n-type semiconductor film is formed of at least one kind of semiconductor selected from the group consisting of an oxide semiconductor, a nitride semiconductor, and an oxynitride semiconductor.

6. A method for generating hydrogen, the method comprising:
(a) preparing the photoelectrochemical cell according to claim 1, and
(b) irradiating the second conductive layer with light to generate hydrogen on the second conductive layer.

7. An energy system, comprising:
the photoelectrochemical cell according to claim 1;
a hydrogen reservoir for storing hydrogen generated in the photoelectrochemical cell,
a first pipe for connecting the hydrogen reservoir to the photoelectrochemical cell;
a fuel cell for converting hydrogen stored in the hydrogen reservoir into electric power; and
a second pipe for connecting the fuel cell to the hydrogen reservoir.

8. A photoelectrochemical cell, comprising:
a semiconductor photoelectrode which functions as an anode electrode;
a counter electrode which functions as a cathode electrode;
an electrolyte aqueous solution which is in contact with surfaces of the semiconductor photoelectrode and the counter electrode; and
a container containing the semiconductor photoelectrode, the counter electrode, and the electrolyte aqueous solution, wherein
the semiconductor photoelectrode includes:
a first conductive layer;
a p-type semiconductor layer disposed on the first conductive layer; and
a second conductive layer which completely covers a surface of the p-type semiconductor layer;
the p-type semiconductor layer has a first p-type surface region and a second p-type surface region;
the first p-type surface region is in contact with the first conductive layer;
the second p-type surface region is in contact with the second conductive layer;
a band edge level E_{C1} of a conduction band in the first p-type surface region is not higher than a band edge level E_{CN} of a conduction band in the second p-type surface region;
a band edge level E_{V1} of a valence band in the first p-type surface region is not higher than a band edge level E_{VN} of a valence band in the second p-type surface region;
a Fermi level E_{FN} of the second p-type surface region is not higher than a Fermi level E_{F1} of the first p-type surface region;
the Fermi level E_{F1} of the first p-type surface region is lower than a Fermi level E_{FC} of the first conductive layer;
a Fermi level E_{FT} of the second conductive layer is lower than the Fermi level E_{FN} of the second p-type surface region;
the counter electrode is electrically connected to the first conductive layer;
the second conductive layer is light-transmissive; and
the second conductive layer functions as a light incident surface.

9. The photoelectrochemical cell according to claim 8, wherein
the p-type semiconductor layer is composed of two or more kinds of elements; and
a concentration of at least one kind of the element included in the p-type semiconductor layer is increased or decreased along a thickness direction of the p-type semiconductor layer.

10. The photoelectrochemical cell according to claim 8, wherein
the p-type semiconductor layer is formed of the at least one kind of semiconductor selected from the group consisting of an oxide semiconductor, a nitride semiconductor, and an oxynitride semiconductor.

11. The photoelectrochemical cell according to claim 8, wherein
the p-type semiconductor layer is composed of a first p-type semiconductor film and a second p-type semiconductor film;
the first p-type semiconductor film is disposed on the first conductive layer;
the second p-type semiconductor film is disposed between the first p-type semiconductor film and the second conductive layer,
a band edge level of a conduction band in the first p-type semiconductor film is not higher than a band edge level of a conduction band in the second p-type semiconductor film;
a band edge level of a valence band in the first p-type semiconductor film is not higher than a band edge level of a valence band in the second p-type semiconductor film;
a Fermi level of the second p-type semiconductor film is lower than a Fermi level of the first p-type semiconductor film;
a Fermi level of the first p-type semiconductor film is lower than a Fermi level of the first conductive layer; and
a Fermi level of the second conductive layer is lower than a Fermi level of the second p-type semiconductor film.

12. The photoelectrochemical cell according to claim 11, wherein
the second p-type semiconductor film is formed of at least one kind of semiconductor selected from the group consisting of an oxide semiconductor, a nitride semiconductor, and an oxynitride semiconductor.

13. A method for generating hydrogen, the method comprising:
(a) preparing the photoelectrochemical cell according to claim 8, and
(b) irradiating the second conductive layer with light to generate hydrogen on the counter electrode.

14. An energy system, comprising:
the photoelectrochemical cell according to claim 8;
a hydrogen reservoir for storing hydrogen generated in the photoelectrochemical cell,
a first pipe for connecting the hydrogen reservoir to the photoelectrochemical cell;
a fuel cell for converting hydrogen stored in the hydrogen reservoir into electric power; and
a second pipe for connecting the fuel cell to the hydrogen reservoir.
